(19) United States
(12) Patent Application Publication
(10) Pub. No.: US 2025/0045102 A1
(43) Pub. Date: Feb. 6, 2025

(54) SYSTEMS, METHODS, AND APPARATUS FOR ASSIGNING COMPUTE TASKS TO COMPUTATIONAL DEVICES

(71) Applicant: Samsung Electronics Co., Ltd., Suwon-si (KR)

(72) Inventors: Wenjie LIU, San Jose, CA (US); Matthew BRYSON, Los Gatos, CA (US); Rajiv SHANMUGAM MADESWARAN, San Jose, CA (US); Naga Sanjana BIKONDA, San Jose, CA (US); Vishwanath MARAM, San Jose, CA (US)

(21) Appl. No.: 18/786,404

(22) Filed: Jul. 26, 2024

Related U.S. Application Data
(60) Provisional application No. 63/530,057, filed on Jul. 31, 2023.

(51) Int. Cl. G06F 9/48

(52) U.S. Cl. CPC G06F 9/4881

(57) ABSTRACT

A method may include determining a first performance of a first compute task on one or more computational devices, wherein the first performance may be determined based on a first weight of the first compute task, determining a second performance of a second compute task on the one or more computational devices, and assigning, based on the first performance and the second performance, the first compute task to at least one of the one or more computational devices. The method may further include determining, based on a characteristic of the first compute task, the first weight. The characteristic of the first compute task may include at least one of a type of the first compute task, computational complexity of the first compute task, priority of the first compute task, latency of the first compute task, or amount of data used by the first compute task.

### REFERENCE TO RELATED APPLICATION

This application claims priority to, and the benefit of, U.S. Provisional Patent Application Ser. No. 63/530,057 filed Jul. 31, 2023 which is incorporated by reference.

### TECHNICAL FIELD

This disclosure relates generally to computational devices, and more specifically to systems, methods, and apparatus for assigning compute tasks to computational devices.

### BACKGROUND

A computational device may include one or more compute resources that it may use to perform one or more compute tasks. A computational device may be used, for example, to offload one or more compute tasks from a host that may run an application implementing a computational workload.

The above information disclosed in this Background section is only for enhancement of understanding of the background of the inventive principles and therefore it may contain information that does not constitute prior art.

### SUMMARY

A method may include: determining, by at least one control circuit, a first performance of a first compute task on one or more computational devices, wherein the first performance may be determined based on a first weight of the first compute task, determining, by the at least one control circuit, a second performance of a second compute task on the one or more computational devices, and assigning, by the at least one control circuit, based on the first performance and the second performance, the first compute task to at least one of the one or more computational devices. The second performance may be determined based on a second weight of the second compute task. The method may further include determining, based on a characteristic of the first compute task, the first weight. The characteristic of the first compute task may include at least one of a type of the first compute task, computational complexity of the first compute task, priority of the first compute task, latency of the first compute task, or amount of data used by the first compute task. The method may further include assigning, by the at least one control circuit, based on the first performance and the second performance, the second compute task to the at least one of the one or more computational devices. The at least one of the one or more computational devices may include a first one of the one or more computational devices, the method may further include assigning, by the at least one control circuit, based on the first performance and the second performance, the second compute task to a second one of the one or more computational devices. The method may further include determining a weight of a data transfer associated with the first compute task, wherein the determining the first performance may be based on the weight of the data transfer associated with the first compute task. The weight of a data transfer associated with the first compute task may be based on at least one of an amount of data transferred by the data transfer, a latency of the data transfer, a type of data access operation associated with the data transfer, or a location of data transferred by the data transfer. The first performance may include an execution speed. The first performance may include an energy consumption. The at least one of the one or more computational devices may include a first one of the one or more computational devices, the method may further include determining a characteristic of the first one of the one or more computational devices, and determining the first performance may be based on the characteristic of the first one of the one or more computational devices. The characteristic of the first one of the one or more computational devices may include at least one of a processing power, energy consumption, or data transfer rate. The method may further include determining a characteristic of a second one of the one or more computational devices, and the determining the second performance may be based on the characteristic of the second one of the one or more computational devices. The first compute task may include at least one instruction, the method may further include compiling, based on the assigning, the at least one instruction for the at least one of the one or more computational devices.

A method may include: determining, by at least one control circuit, a first performance of a computational workload comprising a compute task and a data transfer associated with the compute task, wherein the first performance may be determined based on: a weight of the data transfer, and a second performance of the compute task on at least one of one or more computational devices, and assigning, by the at least one control circuit, based on the first performance, the compute task to the at least one of the one or more computational devices. The method may further include determining, based on a characteristic of the data transfer, the weight of the data transfer. The weight of the data transfer may be based on at least one of an amount of data transferred by the data transfer, a latency of the data transfer, a type of data access operation associated with the data transfer, or a location of data transferred by the data transfer.

A system may include: one or more computational devices, and at least one control circuit configured to: determine a first performance of a compute task on at least a first one of the one or more the computational devices, wherein the first performance of the compute task may be based on a weight of the compute task, determine a second performance of the compute task on at least a second one of the one or more the computational devices, and assign, based on the first performance and the second performance, the compute task to the first one of the one or more computational devices. The weight of the compute task may be based on a characteristic of the compute task. The characteristic of the compute task may include at least one of a type of the compute task, computational complexity of the compute task, priority of the compute task, latency of the compute task, or amount of data used by the compute task.

### BRIEF DESCRIPTION OF THE DRAWINGS

The figures are not necessarily drawn to scale and elements of similar structures or functions may generally be represented by like reference numerals or portions thereof for illustrative purposes throughout the figures. The figures are only intended to facilitate the description of the various embodiments described herein. The figures do not describe every aspect of the teachings disclosed herein and do not limit the scope of the claims. To prevent the drawings from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1 illustrates an embodiment of a computing system in accordance with example embodiments of the disclosure.

FIG. 2 illustrates an embodiment of a scheme for assigning compute tasks to one or more computational devices in accordance with example embodiments of the disclosure.

FIG. 3 illustrates an embodiment of a computing system in accordance with example embodiments of the disclosure.

FIG. 4 illustrates an example embodiment of a method for determining one or more characteristics of one or more computational devices in accordance with example embodiments of the disclosure.

FIG. 5 illustrates an example embodiment of a method for building a workload graph in accordance with example embodiments of the disclosure.

FIG. 6 illustrates an example embodiment of a workload graph in accordance with example embodiments of the disclosure.

FIG. 7 illustrates an example embodiment of a workload graph having one or more nodes and/or edges in accordance with example embodiments of the disclosure.

FIG. 8 illustrates an example embodiment of a method for determining one or more graph weights in accordance with example embodiments of the disclosure.

FIG. 9 illustrates an example embodiment of a workload graph having one or more weights in accordance with example embodiments of the disclosure.

FIG. 10 illustrates an example embodiment of a method for assigning one or more compute tasks to one or more computational devices in accordance with example embodiments of the disclosure,

FIG. 11A illustrates an embodiment of a computing system with a task assignment manager in accordance with example embodiments of the disclosure.

FIG. 11B illustrates an example embodiment of a graph for a computational workload in accordance with example embodiments of the disclosure.

FIG. 12 illustrates an example embodiment of a computing system in accordance with example embodiments of the disclosure.

### DETAILED DESCRIPTION

A computing system may include one or more computational devices to perform compute tasks for a computational workload. For example, a host may assign (e.g., offload) a compute task to a computational device such as a central processing unit (CPU), a graphics processing unit (GPU), a computational storage device (CSD), and/or the like. Depending on the implementation details, a computational device may perform a compute task more effectively than a host in terms of throughput, bandwidth, energy consumption, and/or the like.

Assigning a compute task to a suitable computational device may involve considerations of various factors such as one or more characteristics of the compute task (e.g., the complexity of the task, the amount of data that may be used and/or generated by the task, and/or the like), one or more performance characteristics of the computational device (e.g., processing power, energy efficiency, and/or the like), the location of data that may be used and/or generated by the compute task, and/or other factors. However, some computing systems may not adequately address (e.g., balance) one or more of these factors. For example, some computing systems may assign a compute task to a computational storage device on which input data for the compute task is stored even though a GPU that may perform the compute task faster may remain idle. Depending on the implementation details, this may result in underutilized compute resources that may reduce the performance of the computing system.

A scheme for assigning compute tasks in accordance with example embodiments of the disclosure may assign one or more compute tasks to one or more computational devices based on one or more characteristics of compute tasks and/or data transfers associated with compute tasks, one or more performance characteristics of the one or more computational devices, and/or the like. Depending on the implementation details, this may enable the scheme to distribute one or more compute tasks for a computational workload to one or more computational devices in a manner that may improve the operation of a computing system (e.g., of one or more components and/or the overall system) in terms of throughput, bandwidth, energy consumption, and/or the like.

In some embodiments, a task assignment scheme may determine one or more performance characteristics of one or more computational devices. For example, some embodiments may determine a processing power (e.g., speed) and/or energy efficiency of one or more (e.g., each) computational devices in a computing system. Some embodiments may determine an initial (e.g., expected) processing power and/or energy efficiency of a computational device (e.g., at initialization) and modify the initial processing power and/or energy efficiency based on monitoring one or more actual compute tasks performed by the computational device.

Additionally, or alternatively, a task assignment scheme in accordance with example embodiments of the disclosure may generate a representation of a computational workload. For example, some embodiments may generate a data structure such as a graph in which one or more nodes may represent one or more compute tasks, and an edge between nodes may represent a data transfer (e.g., a dependency) between compute tasks.

Additionally, or alternatively, a task assignment scheme in accordance with example embodiments of the disclosure may determine one or more characteristics of a compute task, a data transfer, and/or the like. In some embodiments, a task assignment scheme may represent one or more characteristics of a compute task, a data transfer, and/or the like using a data structure such as a graph. For example, some embodiments may use a characteristic of a compute task or a data transfer to determine a weight of a corresponding node or edge of a graph, respectively. In some embodiments, a task assignment scheme may use a representation of a computational workload and/or one or more characteristics of one or more compute tasks and/or data transfers (e.g., a graph and/or one or more weights of graph elements) to assign one or more compute tasks to one or more computational devices.

Additionally, or alternatively, a task assignment scheme in accordance with example embodiments of the disclosure may assign one or more compute tasks to one or more computational devices based on determining a performance (e.g., an estimated performance) of one or more compute tasks on one or more computational devices. For example, a method may determine a first performance of a computational workload in which a first computational device may execute a first compute task and a second compute task. The method may determine a second performance of the computational workload in which the first computational device may execute the first compute task and a second computational device may execute the second compute task. The method may assign the first compute task and the second compute task to the first computational device and/or the second computational device based, for example, on a comparison of the first performance and the second performance.

In some embodiments, a task assignment scheme may consider one or more system compute resources (e.g., one or more system compute resource constraints), one or more system energy characteristics (e.g., one or more system energy consumption constraints), and/or the like, to determine one or more assignments of one or more compute tasks for a computational workload to one or more computational devices.

This disclosure encompasses numerous aspects relating to the assignment of compute tasks to computational devices. The aspects disclosed herein may have independent utility and may be embodied individually, and not every embodiment may utilize every aspect. Moreover, the aspects may also be embodied in various combinations, some of which may amplify some benefits of the individual aspects in a synergistic manner.

For purposes of illustration, some embodiments may be described in the context of some specific implementation details such as specific types of compute tasks, computational devices, compute resources, data connections, component configurations, and/or the like. However, the aspects of the disclosure are not limited to these or any other implementation details.

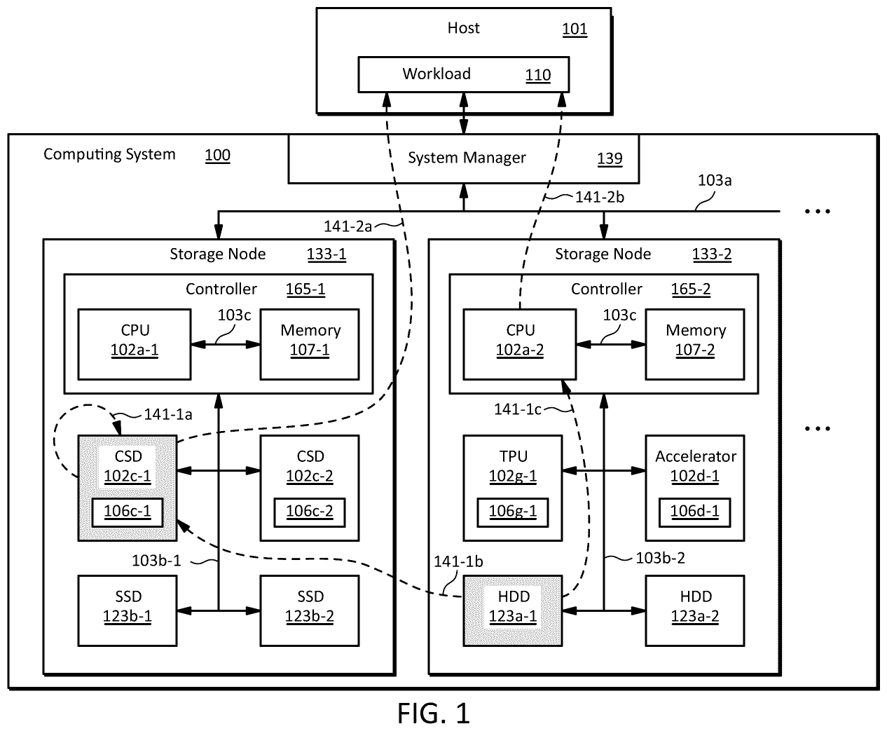

FIG. 1 illustrates an embodiment of a computing system in accordance with example embodiments of the disclosure. The computing system 100 illustrated in FIG. 1 may include one or more system managers 139 and one or more computational devices such as one or more CPUs 102a, one or more computational storage devices 102c, one or more accelerators 102d (which may be implemented, for example, with one or more GPUs, field programmable gate arrays (FPGAs), application specific integrated circuits (ASICs), and/or the like), one or more tensor processing units (TPUs) 102g, and/or the like. The computing system 100 may perform a workload 110 for a host 101 or other user (which may be referred to as a client) of the computing system 100.

Multiple instances of elements identified in this disclosure using the same base numbers and different suffixes may be referred to individually and/or collectively by the base number. For example, one or more computational devices 102a, 102b, 102c, . . . illustrated in FIG. 1 may be referred to individually and/or collectively as computational device(s) 102. As another example, one or more operations 1076-1, 1076-2, . . . of a method may be referred to individually and/or collectively as a method 1076.

The one or more computational devices 102 may be located at one or more apparatus nodes 133-1, 133-2, . . . . For convenience (e.g., to distinguish apparatus nodes from graph nodes), one or more apparatus nodes 133 may be illustrated and/or referred to as storage nodes, but any of the nodes 133 discussed herein (including any nodes 133 referred to as storage nodes) may be implemented with any type of apparatus such with one or more storage nodes (e.g., computational storage nodes), compute nodes, network nodes, and/or the like. In some embodiments, one or more CPUs 102a at one or more storage nodes 133 may function as a controller 165 for a corresponding storage node 133.

The computing system 100 may also include one or more storage devices 123, for example, one or more hard disk drives (HDDs) 123a, one or more solid state drives (SSDs) 123b, and/or the like.

The computing system 100 may also include one or more communication connections 103a, 103b, 103c, and/or others, which may be referred to individually and/or collectively as 103 and which may be arranged in any configuration that may enable communication, directly and/or indirectly, between various components.

Any of the communication connections 103 may be implemented with one or more interconnects, networks, and/or the like, or a combination thereof, using any interfaces, protocols, and/or the like such as Peripheral Component Interconnect Express (PCIe), Nonvolatile Memory Express (NVMe), NVMe over Fabric (NV Me-oF), Compute Express Link (CXL) and/or one or more CXL protocols such as CXL.mem, CXL.cache, CXL.io and/or the like, Ethernet, Direct Memory Access (DMA), Remote DMA (RDNMA), RDMA over Converged Ethernet (ROCE), and/or the like.

The one or more communication connections 103a (e.g., a communication fabric 103a) may enable communications between one or more modes 133, between a storage node 133 and a system manager 139, and/or any combination thereof. As another example, one or more communication connections 103b (e.g., one or more communication fabrics 103b-1, 103b-2, and/or the like) may enable communications between one or more computational devices 102 within a storage node 133. As a further example, one or more communication connections 103c (e.g., one or more communication fabrics 103c) may enable communications between one or more CPUs 102a and one or more memory media 107.

Although the communication connections 103a, 103b, and/or 103c may be illustrated as separate components, in some embodiments, some or all of the communication connections 103a, 103b, and/or 103c, or any portions thereof, may be configured and/or operate, at least in part, as a unified communication connection (e.g., as one communication fabric).

In the computing system 100 illustrated in FIG. 1, data may flow between one or more or more components using one or more communication connections 103 as shown by solid lines, whereas a workload execution (e.g., one or more compute tasks, one or more data transfers associated with one or more compute tasks, and/or the like) may flow through the system 100 as shown by dashed lines 141.

Although the computing system 100 illustrated in FIG. 1 is not limited to any specific operations, in one example usage of the system 100, a first portion of input data (e.g., one or more operands) for a compute task may initially be stored at a computational storage device 102c-1 at storage node 133-1, and a second portion of input data for the compute task may initially be stored at storage device (e.g., an HDD) 123a-1 at storage node 133-2. The compute task may be assigned to the computational storage device 102c-1 (e.g., by a storage manager 139) because the first portion of the input data may be stored at the computational storage device 102c-1. Thus, one or more compute resources 106c-1 at the computational storage device 102c-1 may perform a first portion of the workload using the input data stored at the computational storage device 102c-1 as shown by arrow 141-1a.

In a first implementation of the workload, the second portion of input data for the compute task may transferred from the storage device 123a-1 at storage node 133-2 to the computational storage device 102c-1 at storage node 133-1 so the one or more compute resources 106c-1 may perform a second portion of the compute task using the second portion of input data (as shown by arrow 141-1b). Output data (e.g., one or more results) from the compute task may be sent, for example, to the host 101 as shown by arrow 141-2a.

Depending on the implementation details, however, the one or more compute resources 106c-1 may not have adequate processing power to perform the second portion of the compute task with acceptable speed. Moreover, transferring the second portion of input data to the computational storage device 102c-1 may cause an additional delay in performing the second portion of the compute task. For example, in some embodiments, transferring the second portion of input data may involve a first data transfer through communication connection(s) 103b-2 at storage node 133-2, a second data transfer through communication connection(s) 103a between storage node 133-1 and storage node 133-2, and a third data transfer through communication connection(s) 103b-1 at storage node 133-1.

Alternatively, in a second implementation of the workload, the second portion of input data stored at the storage device 123a-1 at storage node 133-2 may be transferred to a CPU 102a-2 at storage node 133-2 as shown by arrow 141-1c. The CPU 102a-2 may perform the second portion of the compute task and transfer output data (e.g., one or more results) from the compute task to a host or other user as shown by arrow 141-2b. Depending on the implementation details, CPU 102a-2 may be able to perform the second portion of the compute task faster than the one or more compute resources 106c-1 at the computational storage device 102c-1. Moreover, depending on the implementation details, transferring the second portion of input data to CPU 102a-2 using communication connection(s) 103b-2 may be faster than transferring the data to the computational storage device 102c-1. However. CPU 102a-2 may function as a controller, manager, and/or the like, for storage node 133-2, and thus, using CPU 102a-2 to perform the second portion of the compute task may degrade the performance of storage node 133-2.

A task assignment scheme in accordance with example embodiments of the disclosure may distribute one or more compute tasks for a computational workload by: (1) generating one or more performance profiles of computational devices in a system by evaluating one or more performance characteristics such as processing power, energy consumption, data transfer characteristics (e.g., data transfer rate), and/or the like, of the computational device(s); (2) representing the computational workload with one or more data structures such as a weighted graph in which graph nodes may have weights representing one or more characteristics (e.g., complexity) of compute tasks, and edges may have weights representing data traffic between graph nodes; (3) using the profiles and/or weighted graphs to determine (e.g., estimate) one or more performances (e.g., completion speed, energy consumption, and/or the like) of one or more compute tasks on one or more computational device (e.g., performances based on various combinations of compute tasks and computational devices); and/or (4) using the determined performances to assign one or more compute tasks to one or more computational devices in a manner that may consider factors such as utilization and/or performances of individual devices and/or the overall system, data transfer overhead, the numbers, types, configurations, and/or the like, of one or more system compute resources (e.g., one or more system compute resource constraints), one or more system energy characteristics (e.g., one or more system energy consumption constraints), and/or the like, as described in more detail below.

Depending on the implementation details, a task assignment scheme in accordance with example embodiments of the disclosure may improve the operation of one or more components and/or the overall performance of a computing system, for example, in terms of throughput, bandwidth, energy consumption, and/or the like, as described in more detail below.

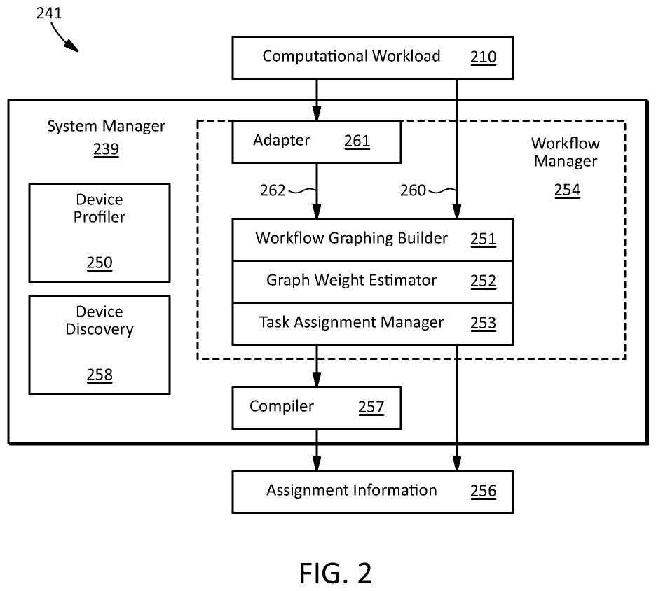

FIG. 2 illustrates an embodiment of a scheme for assigning compute tasks to one or more computational devices in accordance with example embodiments of the disclosure. The scheme 241 illustrated in FIG. 2 may be implemented with a system manager 239 similar to the system manager 139 illustrated in FIG. 1 which may be implemented, for example, with hardware and/or software located at a server in the computing system 100, However, any of the functionality illustrated and/or described with respect to FIG. 2 may be implemented in any other configuration. For example, in some embodiments, some or all of the functionality illustrated and/or described with respect to FIG. 2 may be implemented with hardware and/or software located at one or more storage nodes (e.g., storage nodes 133 illustrated in FIG. 1), one or more computational devices (e.g., computational devices 102 illustrated in FIG. 1), one or more hosts or other users, one or more additional servers, chassis, racks, datacenters, and/or the like.

Referring to FIG. 2, the scheme 241 may include a device profiler 250, workload graph builder 251, graph weight estimator 252, and/or task assignment manager 253. In some embodiments, the workload graph builder 251, graph weight estimator 252, and/or task assignment manager 253 may be referred to and/or characterized, individually and/or collectively, as a workflow manager 254.

In some embodiments, the scheme 241 may include a device discovery feature 258 that may determine the presence, configuration, availability, and/or the like, of one or more computational devices in a computing system. The device discovery feature 258 may generate anti/or update a data structure including entries for one or more computational devices, for example, at system start up (e.g., initialization), when a computational device is hot swapped (e.g., added to a computing system while the system is operating, and/or the like. The device discovery feature 258 may be used, for example, by the device profiler 250 to determine which devices to create profiles for.

The device profiler 250 may determine a performance profile (e.g., one or more performance characteristics) of one or more computational devices (e.g., each discovered device) in a computing system. For example, the device profiler 250 may determine a processing power (e.g., processing speed), data transfer rate, and/or energy efficiency of one or more computational devices in a computing system.

The workload graph builder 251 may receive a representation of a computational workload 210 in a form, for example, of one or more programs, applications, data structures (e.g., tables, linked lists, and/or the like), functions, subroutines, and/or the like. For example, in some embodiments, a representation of a computational workload 210 may include one or more computational device functions (CDFs) computational storage functions (CSFs) (e.g., a CSF specified by the Storage Networking Industry Association (SNIA)), one or more computational programs (e.g., a computational program specified by a NVMe specification), and/or the like.

The computational workload 210 may be received from a host or other user of the scheme 241, computing system 100, and/or the like, such as an application, process, service, virtual machine (VM), VM manager, operating system, and/or the like, running on a host. The workload graph builder 251 may use a representation of a computational workload 210 in the form in which it is received as shown by arrow 260. Additionally, or alternatively, the scheme 241 may include one or more adapters 261 that may translate a representation of a computational workload 210 to an intermediate representation a shown by arrow 262. For example, in some embodiments, the scheme 241 may include one or more adapters corresponding to one or more formats that may be used for a representation of a computational workload 210. Depending on the implementation details, this may enable the workload graph builder 251 to use a common format (e.g., an intermediate representation) to process representations of multiple computational workloads 210 received in multiple formats.

The workload graph builder 251 may use a representation of a computational workload 210 to generate a data structure such as a graph in which one or more nodes may represent one or more compute tasks, and an edge between nodes may represent a data transfer (e.g., a dependency) between compute tasks.

In some embodiments, the workload graph builder 251 may identify one or more compute tasks that may be represented as one or more nodes of a graph, for example, by searching for one or more elements such as one or more functions, instructions, data structures, calls, arguments, parameters, dependencies, data transfers, and/or the like, within a representation of a computational workload 210, that may indicate that the one or more identified elements may be identified, handled, managed, and/or the like, as one or more compute tasks (e.g., one or more distinct compute tasks). In some embodiments, a compute task may refer to one or more operations that may be offloaded to a computational device.

In some embodiments, the workload graph builder 251 may identify one or more data transfers (e.g., dependencies) between compute tasks that may be represented as one or more edges of a graph, for example, by searching for one or more elements such as one or more functions, instructions, data structures, calls, arguments, parameters, and/or the like, within a representation of a computational workload 210, that may indicate that a data transfer (e.g., a dependency) may be involved between one or more compute tasks.

The graph weight estimator 252 may determine one or more characteristics of one or more compute tasks, data transfers, and/or the like, that may be represented by one or more nodes and/or edges in a graph generated by the workload graph builder 251. The graph weight estimator 252 may use the one or more determined characteristics to quantify (e.g., assign one or more weights to) one or more nodes and/or edges in a graph.

Examples of compute task characteristics that may yield a weight for a node may include a type of task, computational complexity, priority of task, latency (e.g., specified execution time), memory requirements (e.g., amount of input data, output data, and/or intermediate data), and/or the like. For example, some types of tasks such as calculations (e.g., matrix multiplication, encryption and/or decryption, compression and/or decompression, checksum calculation, hash value calculation, cyclic redundancy check (CRC) calculations, training (e.g., weight calculations) for artificial intelligence and/or machine learning (AIML) models, inference using AIML models, and/or the like) may be assigned higher weights, whereas other types of tasks such as data movement, data management, data selection, filtering, and/or the like, may be assigned lower weights. As another example, tasks with higher computational complexity (e.g., matrix multiplication with matrices having larger dimensions, video processing with higher resolution images, encryption/decryption with larger key sizes, and/or the like) may be assigned higher weights than similar tasks with lower computations intensity (e.g., smaller dimensions, lower resolution, smaller key sizes, and/or the like). As a further example, tasks with higher priority (e.g., real-time processing for automated driving, intrusion detection for security systems, recommendations for ecommerce, and/or the like) may be assigned a higher weight than tasks with lower priority such as offline processing of batch data.

Examples of data transfer characteristics that may yield a weight for an edge may include an amount of data to transfer, a latency (e.g., a specified length of time for the data transfer), a type of data access operation associated with the data transfer, a locality of the data to be transferred and/or the like. For example, a transfer of a relatively large amount of data may be assigned a higher weight than a transfer of a relatively small amount of data. As another example, a data transfer that involves accessing the data randomly from memory or storage may be assigned a higher weight than transferring data may be accessed sequentially. As a further example, a data transfer that involves a relatively remote source and/or destination and/or a relatively slower protocol, interface and/or the like (e.g., at a different server, chassis, rack, datacenter, and/or the like, and/or using RDMA, ROCE, and/or the like) may be assigned a higher weight than a data transfer that involves a relatively close source and/or destination and/or a relatively faster protocol, interface and/or the like (e.g., at the same server, and/or using PCIe, CXL, and/or the like).

The task assignment manager 253 may use a representation of a computational workload (e.g., a graph having weighted nodes and/or edges that may be generated by the workload graph builder 251) and/or a performance profile of one or more computational devices (e.g., one or more performance characteristics that may be determined by the device profiler 250) to assign one or more compute tasks to one or more computational devices. In some embodiments, the task assignment manager 253 may determine (e.g., estimate) one or more performances (e.g., completion speed, energy consumption, and/or the like) of one or more compute tasks on one or more computational devices (e.g., performances based on various combinations of compute tasks and computational devices) and use the performances to assign one or more compute tasks to one or more computational devices.

An assignment may be based on one or more factors such as utilization and/or performances of individual devices and/or the overall system, data transfer overhead, the numbers, types, configurations, and/or the like, of computational devices in a system, and/or the like.

For example, the task assignment manager 253 may determine a first performance of a computational workload in which one computational device may execute a first compute task and a second compute task. The task assignment manager 253 may determine the first performance, for example, by: (1) using the weight of the first compute task and a performance profile of the computational device to calculate a first estimate of an execution time and/or energy consumption associated with executing the first task on the computational device; (2) using the weight of the second compute task and the performance profile of the computational device to calculate a second estimate of an execution time and/or energy consumption associated with executing the first task on the computational device; (3) using a weight of one or more edges (e.g., data transfers) associated with the first and second compute tasks to calculate a third estimate of a data transfer time; and (4) using the first, second, and/or third estimates to calculate an overall estimated execution time and/or energy consumption for the workload.

The task assignment manager 253 may also determine a second performance of the same computational workload in which a first computational device may execute the first compute task and a second computational device may execute the second compute task. The task assignment manager 253 may determine the second performance, for example, by: (1) using the weight of the first compute task and a performance profile of the first computational device to calculate a first estimate of an execution time and/or energy consumption associated with executing the first task on the first computational device; (2) using the weight of the second compute task and a performance profile of the second computational device to calculate a second estimate of an execution time and/or energy consumption associated with executing the first task on the second computational device; (3) using a weight of one or more edges (e.g., data transfers) associated with the first and second compute tasks to calculate a third estimate of a data transfer time; and (4) using the first, second, and/or third estimates to calculate an overall estimated execution time and/or energy consumption for the workload.

The task assignment manager 253 may then compare the first performance to the second performance and assign the first and second compute tasks to the first and/or second computational devices based on which performance may improve (e.g., optimize) the performance of one or more computational devices, compute tasks, the overall computing system, the overall workload, and/or the like, in terms of throughput, bandwidth, energy consumption, and/or the like.

In some embodiments, the task assignment manager 253 may implement an assignment of a compute task to a computational device, for example, by generating assignment information 256 which may include one or more instructions, indications, and/or the like, that may be sent to a computational device to which a compute task may be assigned. Additionally, or alternatively, the assignment information 256 may include code that may be compiled (e.g., by a compiler 257) for a compute task to run on a computational device to which the compute task may be assigned. Additionally, or alternatively, the assignment information 256 may include task scheduling information for one or more compute tasks on one or more computational devices. Task scheduling information may be used, for example, by an execution environment (e.g., a runtime environment), a virtual machine, an operating system scheduler, and/or the like.

Additionally, or alternatively, the assignment information 256 may include one or more instructions, indications, and/or the like, that may cause one or more configurable compute resources at a computational device to load, execute, and/or the like, one or more functions, programs, and/or the like (e.g., computational device functions, computational storage functions, FPGA programs, and/or the like).

Additionally, or alternatively, the task assignment manager 253 may implement an assignment of a compute task to a computational device by placing a compute task in a queue (e.g., for a computational device), by inserting one or more annotations (e.g., one or more comments) indicating the assignment in code (e.g., annotated code) such that a compiler, interpreter, and/or the like, may use to cause the compute task to be executed using the computational device, and/or in any other suitable manner.

In some embodiments, any or all of the functionality illustrated and/or described with respect to FIG. 2 may be implemented with one or more application programming interfaces (APIs). For example, the scheme 241 may use one or more APIs to enable a system administrator, software developer, and/or the like, to provide information such as configuration information for one or more computational devices, complexity information for one or more compute tasks, data input and/or output ratios for one or more compute tasks, preferences for prioritizing one or more performance characteristics such as processing speed, energy consumption, and/or the like, energy consumption budgets (e.g., constraints), and/or the like.

Additionally, or alternatively, the scheme 241 may use one or more APIs to enable one or more hosts and/or other users of a computing system such as an application, process, service, VM, VM manager, operating system, and/or the like, to access any or all of the functionality illustrated and/or described with respect to FIG. 2.

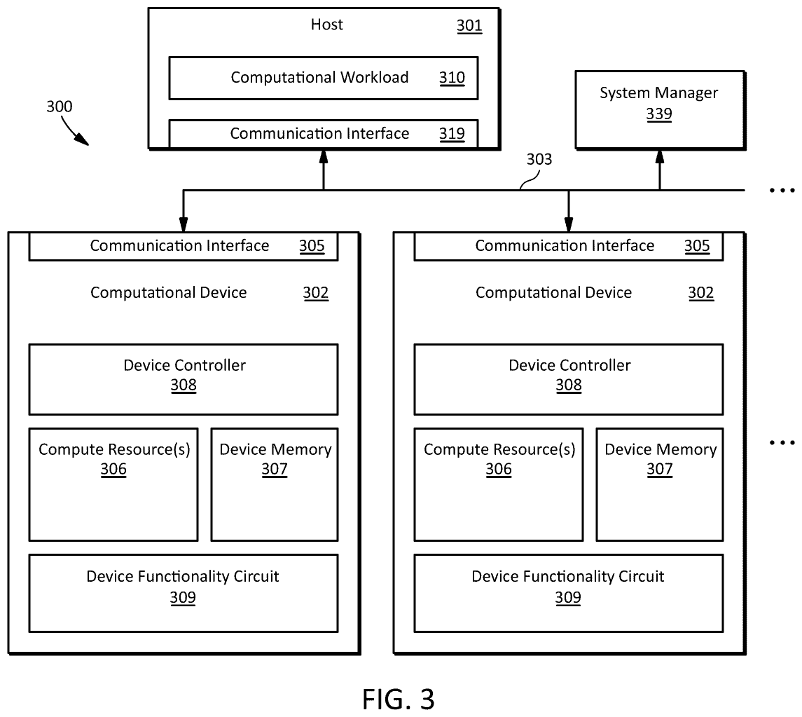

FIG. 3 illustrates an embodiment of a computing system in accordance with example embodiments of the disclosure. The computing system 300 illustrated in FIG. 3 may be used to implement, and/or implemented with, any of the assignment schemes disclosed herein, including those described with respect to other drawings in which similar elements may be indicated by reference numbers ending in, and/or containing, the same digits, letters, and/or the like.

The computing system 300 illustrated in FIG. 3 may include a host 301, one or more computational devices 302, and/or a system manager 339 that may be configured to communicate using one or more communication connections 303. In some embodiments, the host 301 may be implemented with more than one host which may be referred to individually and/or collectively as host 301.

The system manager 339 may include any or all of the functionality that may implement any of the compute task assignment schemes disclosed herein, including any or all of the functionality included in the system mangers 139 and/or 239 illustrated and/or described with respect to FIG. 1 and/or FIG. 2. Any or all of the functionality implemented with, or used to implement, the system manager 339 may be located anywhere including at least partially at a component 339 as illustrated in FIG. 3, at a host 301, at one or more computational devices 302, and/or at any other location, or a combination thereof (e.g., distributed at different components).

Any of the components illustrated and/or described with respect to FIG. 3 may be arranged individually and/or in groups at any locations such as one or more nodes, servers, chassis, racks, clusters, datacenters, edge datacenters, and/or the like. In some embodiments, an arrangement of one or more devices, whether located individually, in nodes, and/or the like, may be referred to and/or characterized as a cluster. For example, some or all of the computational devices 102 and/or storage devices 123 illustrated in FIG. 1 may be referred to as components of a cluster in which one or more storage nodes 133 may be implemented with one or more servers, and the system manager 139 (which may be located at one of the storage nodes 133, at a separate server, and/or the like) may operate as a cluster manager.

Although the one or more communication connections 303 may be illustrated as being separate from other components, in some embodiments, one or more other components may be integral with, and/or configured within, the one or more communication connections 303, between one or more other components using the one or more communication connections 303, and/or the like. For example, in some embodiments, the system manager 339 may be located between portions of the one or more communication connections 303 in a manner similar to the system mangers 139 and/or 239 illustrated and/or described with respect to FIG. 1 and/or FIG. 2.

The one or more communication connections 303 may implement, and/or be implemented with, one or more interconnects, one or more networks, a network of networks (e.g., an internet), and/or the like, or a combination thereof, using any type of interface, protocol, and/or the like. For example, the one or more communication connections 303 may implement, and/or be implemented with, any type of wired and/or wireless communication medium, interface, network, interconnect, protocol, and/or the like including PCIe, NVMe, NVMe over Fabric (NVMe-oF), Compute Express Link (CXL), and/or a coherent protocol such as CXL.mem, CXL.cache, CXL.io and/or the like, Gen-Z, Open Coherent Accelerator Processor Interface (OpenCAPI), Cache Coherent Interconnect for Accelerators (CCIX), and/or the like, Advanced eXtensible Interface (AXI), Direct Memory Access (DMA), Remote DMA (RDMA), RDMA over Converged Ethernet (ROCE), Advanced Message Queuing Protocol (AMQP), Ethernet, Transmission Control Protocol/Internet Protocol (TCP/IP), FibreChannel, InfiniBand, Serial ATA (SATA), Small Computer Systems Interface (SCSI), Serial Attached SCSI (SAS), iWARP, any generation of wireless network including 2G, 3G, 4G, 5G, 6G, and/or the like, any generation of Wi-Fi, Bluetooth, near-field communication (NFC), and/or the like, or any combination thereof. In some embodiments, a communication connection 303 may include one or more switches, hubs, nodes, routers, and/or the like.

A host 301 may be implemented with any component or combination of components that may utilize one or more features of a computational device 302. For example, a host may be implemented with one or more of a server, a storage node, a compute node, a central processing unit (CPU), a workstation, a personal computer, a tablet computer, a smartphone, and/or the like, or multiples and/or combinations thereof. In some embodiments, a host 301 may include one or more communication interfaces 319 that may be used to implement any or all of the one or more communication connections 303.

In some embodiments, a host 301 may be a source of one or more computational workloads 310 having one or more compute tasks that may be assigned to one or more computational devices 302 by system manager 339.

A computational device 302 may include a communication interface 305, memory 307 (some or all of which may be referred to as device memory), one or more compute resources 306 (which may also be referred to as computational resources), a device controller 308, and/or a device functionality circuit 309. The device controller 308 may control the overall operation of the computational device 302 including any of the operations, features, and/or the like, described herein. For example, in some embodiments, the device controller 308 may execute one or more computational tasks received from the host 301 using one or more compute resources 306.

The communication interface 305 (which, in some embodiments, may be implemented with multiple communication interfaces 305) may be used to implement any or all of the one or more communication connections 303.

The device functionality circuit 309 may include any hardware to implement a primary function of the computational device 302. For example, if the computational device 302 is implemented as a storage device (e.g., a computational storage device), the device functionality circuit 309 may include storage media such as magnetic media (e.g., if the computational device 302 is implemented as an HDD or a tape drive), solid state media (e.g., one or more flash memory devices), optical media, and/or the like. For instance, in some embodiments, a storage device may be implemented at least partially as an SSD based on not-AND (NAND) flash memory, persistent memory (PMEM) such as cross-gridded nonvolatile memory, memory with bulk resistance change, phase change memory (PCM), or any combination thereof. In an embodiment in which the computational device 302 is implemented as a storage device, the device controller 308 may include a media translation layer such as a flash translation layer (FTL) for interfacing with one or more flash memory devices. In some embodiments, a computational storage device may be implemented as a computational storage drive, a computational storage processor (CSP), and/or a computational storage array (CSA).

As another example, if the computational device 302 is implemented as a network interface controller (NIC) (e.g., a network interface card), the device functionality circuit 309 may include one or more modems, network interfaces, physical layers (PHYs), medium access control layers (MACs), and/or the like. As a further example, if the computational device 302 is implemented as an accelerator, the device functionality circuit 309 may include one or more accelerator circuits, memory circuits, and/or the like.

The one or more compute resources 306 may be implemented with any component or combination of components that may perform operations on data that may be received, stored, and/or generated at the computational device 302. In some embodiments, at least some of the compute resources 306 may be used to implement a device functionality circuit 309, Examples of compute resources may include combinational logic, sequential logic, timers, counters, registers, state machines, complex programmable logic devices (CPLDs), FPGAs, ASICs, embedded processors, microcontrollers, CPUs such as complex instruction set computer (CISC) processors (e.g., x86 processors) and/or a reduced instruction set computer (RISC) processors such as ARM processors, CPUs, data processing units (DPUs), neural processing units (NPUs), tensor processing units (TPUs), and/or the like, that may execute instructions stored in any type of memory and/or implement any type of execution environment such as a container, a virtual machine, an operating system such as Linux, an Extended Berkeley Packet Filter (eBPF) environment, and/or the like, or a combination thereof.

The memory 307 may be used, for example, by one or more of the compute resources 306 to store input data, output data (e.g., computation results), intermediate data, transitional data, and/or the like. The memory 307 may be implemented, for example, with volatile memory such as dynamic random access memory (DRAM), static random access memory (SRAM), and/or the like, as well as any other type of memory such as nonvolatile memory.

In some embodiments, the memory 307 and/or compute resources 306 may include software, instructions, programs, code, and/or the like, that may be performed, executed, and/or the like, using one or more compute resources (e.g., hardware (HW) resources). Examples may include software implemented in any language such as assembly language, C, C++, and/or the like, binary code, FPGA code, one or more operating systems, kernels, environments such as eBPF, and/or the like. Software, instructions, programs, code, and/or the like, may be stored, for example, in memory 307 and/or compute resources 306. Software, instructions, programs, code, and/or the like, may be downloaded, uploaded, sideloaded, pre-installed, built-in, and/or the like, to the memory 307 and/or compute resources 306. In some embodiments, the computational device 302 may receive one or more instructions, commands, and/or the like, to select, enable, activate, execute, and/or the like, software, instructions, programs, code, and/or the like. Examples of computational operations, functions, and/or the like, that may be implemented by the memory 307, compute resources 306, software, instructions, programs, code, and/or the like, may include any type of algorithm, data movement, data management, data selection, filtering, encryption and/or decryption, compression and/or decompression, checksum calculation, hash value calculation, cyclic redundancy check (CRC), weight calculations, activation function calculations, training, inference, classification, regression, and/or the like, for artificial intelligence (AI), machine learning (ML), neural networks, and/or the like.

A computational device 302 or any other component disclosed herein may be implemented in any physical form factor. Examples of form factors may include a 3.5 inch, 2.5 inch, 1.8 inch, and/or the like, storage device (e.g., storage drive) form factor, M.2 device form factor, Enterprise and Data Center Standard Form Factor (EDSFF) (which may include, for example, E1.S, E1 L, E3.S, E3.L, E3.S 2T, E3.L 2T, and/or the like), add-in card (AIC) (e.g., a PCIe card (e.g., PCIe expansion card) form factor including half-height (HH), half-length (HL), half-height, half-length (HHHL), and/or the like), Next-generation Small Form Factor (NGSFF), NF1 form factor, compact flash (CF) form factor, secure digital (SD) card form factor, Personal Computer Memory Card International Association (PCMCIA) device form factor, and/or the like, or a combination thereof. Any of the computational devices disclosed herein may be connected to a system using one or more connectors such as SATA connectors, SCSI connectors, SAS connectors, M.2 connectors, EDSFF connectors (e.g., connectors compatible with SFF-TA-1002 and/or SFF-TA-1009 such as 1C, 2C, 4C, 4C+, and/or the like), U.2 connectors (which may also be referred to as SSD form factor (SFF) SFF-8639 connectors), U.3 connectors, PCIe connectors (e.g., card edge connectors), and/or the like.

Any of the computational devices disclosed herein may be used in connection with one or more personal computers, smart phones, tablet computers, servers, server chassis, server racks, datarooms, datacenters, edge datacenters, mobile edge datacenters, and/or any combinations thereof.

In some embodiments, a computational device 302 may be implemented with any device that may include, or have access to, memory, storage media, and/or the like, to store data that may be processed by one or more compute resources 306. Examples may include memory expansion and/or buffer devices such as CXL type 2 and/or CXL type 3 devices, as well as CXL type 1 devices that may include memory, storage media, and/or the like.

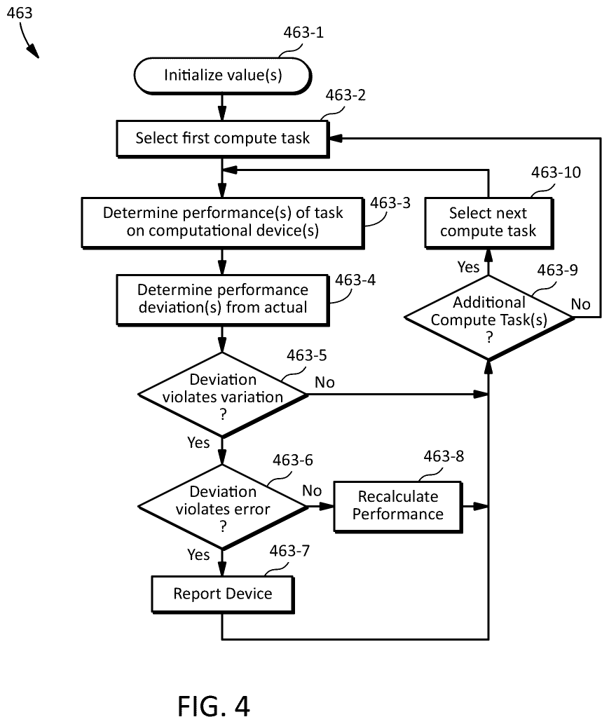

FIG. 4 illustrates an example embodiment of a method for determining one or more characteristics of one or more computational devices in accordance with example embodiments of the disclosure. The method 463 illustrated in FIG. 4 may be used, for example, to implement the device profiler 250 at the system manager 239 illustrated in FIG. 2 and/or any other device profilers, system managers, workflow managers, and/or the like, disclosed herein.

Referring to FIG. 4, the method 463 may be implemented for one or more computational devices in a computing system. For example, in the compute system 300 illustrated in FIG. 3, the system manager 339 may perform the method 463 for one or more (e.g., each) of the computational devices 302.

At operation 463-1, the method may initialize one or more values such as a processing performance (e.g., an estimated processing performance) Pₑ, an energy efficiency (e.g., an estimated energy efficiency) Eₑ, a threshold for processing performance variation Tₚᵥ, a threshold for processing performance error Tₚₑ, a threshold for energy efficiency variation Tₑᵥ, and/or a threshold for energy efficiency error Tₑₑ, for a computational device which may be used, for example, to monitor the performance of one or more computational devices as explained below. Operation 463-1 may be performed, for example, during initialization (e.g., start up, restart, and/or the like) of a computational device. In some embodiments, an initial value of a processing performance and/or an energy efficiency Eₑ may be determined as an estimated value. In some embodiments, an estimated value of Pₑ and/or Eₑ may be updated (e.g., recalculated) based on one or more measurements of the performance of a computational device.

A processing performance Pₑ may be determined based on one or more factors such as a processor architecture, amount of memory, number of processor cores, number of gates, operating speed (e.g., clock frequency, floating point operations per second (flops), and/or the like), data path width, data transfer rate (e.g., GB per second), and/or the like. In some embodiments, information about one or more such factors may be obtained from a device vendor (e.g., as a device specification), Additionally, or alternatively, a processing performance Pₑ may be determined based on one or more measurements of an actual or simulated performance of a computational device (e.g., based on running one or more test calculations, running one or more calculations during actual use, using a simulation model, and/or the like).

In some embodiments, a processing performance F may be determined and/or represented as a relative value. For example, a processing performance of a first computational device (e.g., a reference device) may be assigned a reference value of one (e.g., Pₑ=1), and a processing performance of a second computational device may be expressed as a multiple of the reference value (e.g., a processing performance of a second computational device having 25 percent more processing power than a reference device may be expressed as Pₑ=1.25).

An energy efficiency Eₑ may be based on one or more factors such as an operating power or energy (e.g., watts and/or watt-hours), an operating efficiency (e.g., watt-hours per calculation, watts-hours per amount of data transferred, and/or the like), and/or any other factors that may be used to evaluate an energy efficiency of a computational device. In some embodiments, information about one or more such factors may be obtained from a device vendor (e as a device specification), Additionally, or alternatively, an energy efficiency Eₑ may be determined based on one or more measurements of an actual or simulated energy efficiency of a computational device (e.g., based on running one or more test calculations, running one or more calculations during actual use, using a simulation model, and/or the like).

A threshold for processing performance variation Tₚᵥ may be used to specify an operating range, variation, deviation, and/or the like, for a processing performance Pₑ of a computational device (e.g., an operating range that may be considered normal, acceptable, and/or the like). For example, in some embodiments, a value of Pₑ for a computational device may recalculated if a measured value of Pₑ deviates from an estimated value of Pₑ by an amount greater than Tₚᵥ. Similarly, a threshold for an energy efficiency variation Tₑᵥ may be used to specify an operating range, variation, deviation, and/or the like, for an energy efficiency Eₑ of a computational device (e.g., an operating range that may be considered normal, acceptable, and/or the like) that may cause a recalculation of a value of Eₑ.

A threshold for processing performance error Tₚₑ may be used to specify an error range for a processing performance Pₑ of a computational device (e.g., an operating range that may be considered a malfunction, unacceptable, and/or the like). For example, in some embodiments, if a measured value of Pₑ for a computational device deviates from an estimated value of Pₑ by an amount greater than Tₚₑ, one or more corrective actions may be taken such as disabling the device, removing the device from a computing system, operating the device in a modified mode (e.g., at a reduced speed), reporting the device to an administrator, and/or the like. Similarly, a threshold for an energy efficiency error Tₑₑ may be used to specify an error range for an energy efficiency Eₑ of a computational device (e.g., an operating range that may be considered a malfunction, unacceptable, and/or the like) that may cause a corrective action. In some embodiments, taking a corrective action may help preserve the integrity of data in a computing system.

In some embodiments, an initialization of one or more values of Pₑ, Eₑ, Tₚᵥ, Tₚₑ, Tₑᵥ, and/or Tₑₑ may be performed, for example, during system and/or device initialization, based on one or more user inputs (e.g., specifications), based on one or more measurements, and/or the like. For example, a system administrator may manually and/or programmatically enter, download, and/or the like, one or more values of Pₑ, Eₑ, Tₚᵥ, Tₚₑ, Tₑᵥ, and/or Tₑₑ. In some embodiments, any or all of Pₑ, Eₑ, Tₚᵥ, Tₚₑ, Tₑᵥ, and/or Tₑₑ may be determined on a per task basis, on the basis of multiple tasks, and/or in any other manner.

Referring again to FIG. 4, at operation 463-1, the method may initialize one or more values of Pₑ, Eₑ, Tₚᵥ, Tₚₑ, Tₑᵥ, and/or Tₑₑ and for a computational device and store the one or more values as a profile for the computational device. In some embodiments, operation 463-1 may be repeated for one or more (e.g., each) computational device in a computing system (e.g., a cluster).

At operation 463-2, the method may select a first compute task that may have been assigned to a computational device, A first instance of operation 463-2 may be performed, for example, at the beginning of a computational workload and after a system manager has assigned one or more compute tasks to one or more computational devices, One or more additional instances of operation 463-2 may be performed, for example, during execution of a computational workload (e.g., at one or more intervals).

At operation 463-3, the method may determine (e.g., estimate) one or more performances (e.g., a processing performance and/or an energy efficiency) of the compute task selected at operation 463-2 (or the next task determined at operation 463-10) running on a computational device to which the compute task may have been assigned. Thus, in some embodiments, one or more performances may be determined (e.g., estimated) based on task/device pairs using, for example, one or more characteristics of a compute task (e.g., a computational complexity as determined by workload graph builder 251 and/or graph weight estimator 252) and a profile (e.g., an initial value of Pₑ and/or Eₑ as determined by operation 463-1 and/or an updated value determined by method 463 and/or device profiler 250). A performance may be expressed and/or evaluated, for example, based on an execution time, a data transfer time, a total energy consumption, an energy consumption per calculation, per input and/or output (I/O or IO) operation, per amount of data transferred, and/or the like.

At operation 463-4, the method may compare one or more actual measured performances (e.g., a calculation finish time and/or an energy consumption or efficiency) to one or more estimated performances. For example, the method may determine a processing performance deviation P_{dev} by calculating a difference between an actual processing performance and an estimated processing performance. Additionally, or alternatively, the method may determine an energy efficiency deviation E_{dev} by calculating a difference between an actual energy efficiency and an estimated energy efficiency.

At operation 463-5, the method may compare a performance deviation determined at operation 463-4 to a variation threshold (e.g., Tₚᵥ or Tₑᵥ) to determine whether to recalculate a performance estimate (e.g., determine whether a performance deviation violates a threshold). For example, if a processing performance deviation P_{dev}, is less than Tₚᵥ(P_{dev}<Tₚᵥ) and/or an energy efficiency deviation E_{dev} is less than Tₑᵥ (E_{dev}<Tₑᵥ), the method may proceed to operation 463-10 without recalculating one or more estimated performances.

If, however, at operation 463-5, the method determines that a processing performance deviation P_{dev} and/or an energy efficiency deviation E exceeds a corresponding variation threshold (e.g., P_{dev}>Tₚᵥ and/or E_{dev}>Tₑᵥ), the method may proceed to operation 463-6.

At operation 463-6, the method may compare a performance deviation to an error threshold (e.g., Tₚₑ or Tₑₑ) to determine whether to take a corrective action. For example, if a processing performance deviation P_{dev} is less than Tₚᵥ (Tₚᵥ<P_{dev}<Tₚₑ) and/or an energy efficiency deviation E_{dev} is less than Tₑₑ(Tₑᵥ<E_{dev}<Tₑₑ), the method may proceed to operation 463-8.

At operation 463-8, the method may recalculate one or more estimated performances that may exceed a variation threshold but not an error threshold. For example, the method may use an execution time of a compute task on a computational device to determine a new value of a processing performance P and store it as part of an updated profile for the computational device. As another example, the method may use an energy consumption of a compute task on a computational device to determine a new value of an energy efficiency Eₑ and store it as part of an updated profile for the computational device.

If, at operation 463-6, the method determines that a processing performance deviation P_{dev} and/or an energy efficiency deviation E_{dev} exceeds a corresponding error threshold (e.g., P_{dev}>Tₚᵥ and/or E_{dev}>Tₑₑ) for a computational device, the method may proceed to operation 463-7 where it may take one or more corrective actions such as disabling the device, removing the device from a computing system, operating the device in a modified mode (e.g., at a reduced speed), reporting the device to an administrator, and/or the like, and proceed to operation 463-9.

At operation 463-9, the method may determine if there are any additional assigned compute tasks to process. If there are one or more additional compute tasks to process, the method may proceed to operation 463-10 and select a next task for processing. The method may proceed to process the selected next task using one or more of operations 463-3 through 463-8, then proceed to operation 463-9.

If, at operation 463-9, the method determines that enough (e.g., all) assigned compute tasks have been processed, the method may proceed to operation 463-2 where it may select a first compute task and determine (e.g., estimate) one or more performances of the compute task selected at operation 463-2 (or the next task determined at operation 463-10) running on a computational device to which the compute task may have been assigned. Thus, in some embodiments, the method 463 may monitor the performance of one or more computational devices (e.g., continuously, intermittently, and/or the like) and determine and/or maintain performance profiles and/or determine one or more error conditions for one or more (e.g., all) computational devices in a computing system. Depending on the implementation details, the method 463 may determine and/or maintain one or more performance profiles that may change based on the performance of one or more compute tasks assigned to one or more computational devices in a computing system. For example, if a computational device does not perform as well as expected with a specific compute task, a performance profile for the computational device may be changed to reflect a lower level of performance,

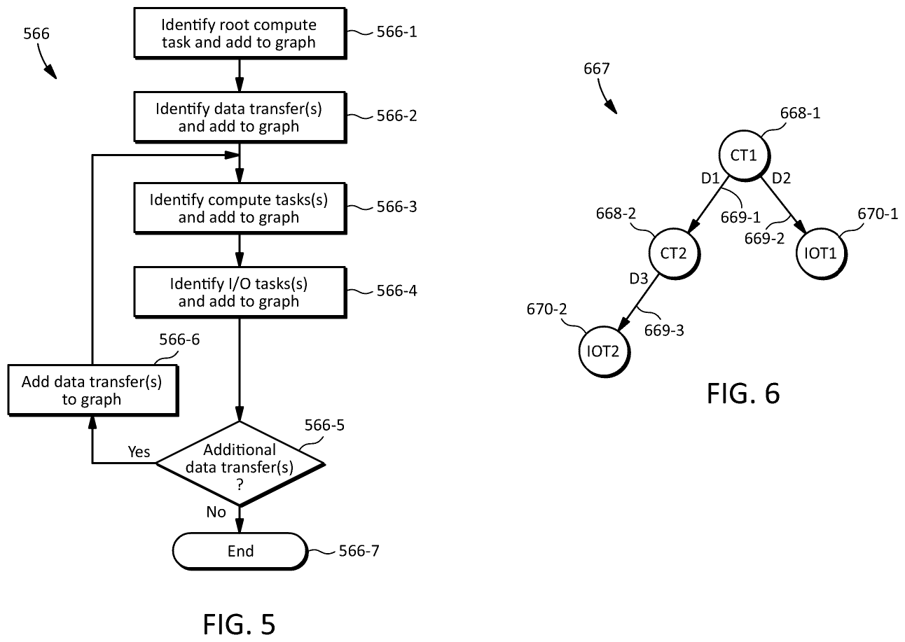

FIG. 5 illustrates an example embodiment of a method for building a workload graph in accordance with example embodiments of the disclosure. The method 566 illustrated in FIG. 5 may be used, for example, to implement the workload graph builder 251 at the system manager 239 illustrated in FIG. 2 and/or any other workload graph builder, system manager, workflow manager, and/or the like, disclosed herein.

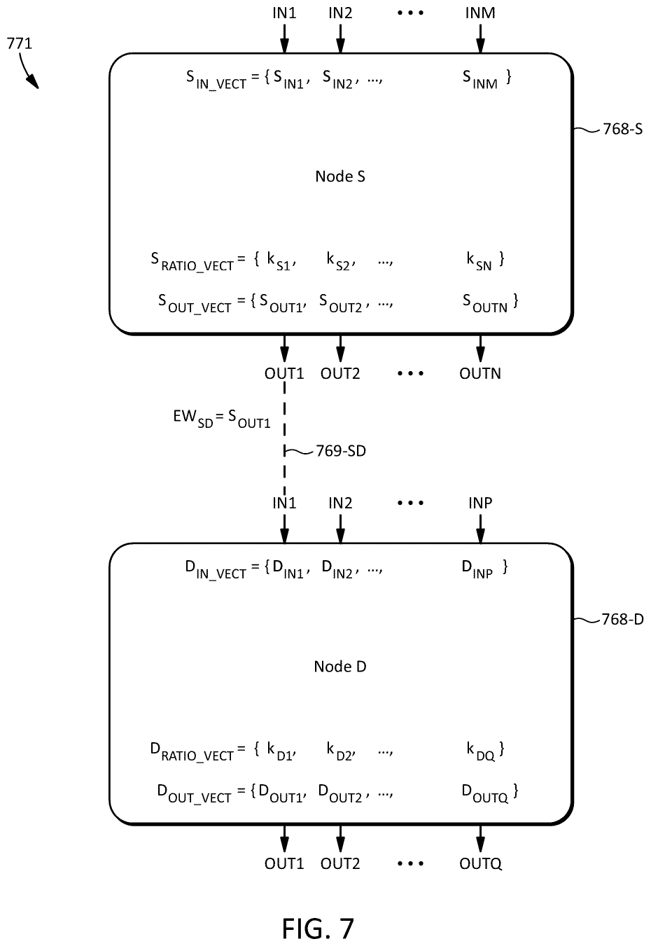

FIG. 6 illustrates an example embodiment of a workload graph in accordance with example embodiments of the disclosure. The workload graph 667 illustrated in FIG. 6 may be used, for example, to illustrate one or more operations of the method 566 illustrated in FIG. 5. However, the method 566 is not limited to any of the specific example details illustrated in FIG. 6.

Referring to FIG. 5 and FIG. 6, at operation 566-1, the method may identify a root compute task in a computational workload and add a node representing the identified root compute task to a graph of the workload. The method may identify a compute task, for example, by searching for one or more elements such as one or more functions, instructions, data structures, calls, arguments, parameters, dependencies, data transfers, and/or the like, within a representation of the computational workload (e.g., a representation of computational workload 210 as illustrated and/or described with reference to FIG. 2) that may indicate that the one or more identified elements may be identified, handled, managed, and/or the like, as one or more compute tasks (e.g., one or more distinct compute tasks) that may be offloaded to one or more computational devices in a computing system.

For example, in the workload graph illustrated in FIG. 6, operation 566-1 may identify a root compute task CT1 and add a first node 668-1 representing the root compute task CT1 to the workload graph 667.

At operation 566-2, the method may identify one or more data transfers from the root node in the workload and add one or more edges representing the identified data transfers to the graph of the workload. The method may identify a data transfer, for example, by searching for one or more elements such as one or more functions, instructions, data structures, calls, arguments, parameters, and/or the like, within a representation of a computational workload that may indicate that a data transfer may be involved between one or more compute tasks and/or between a compute task and one or more IO tasks.

For example, in the workload graph illustrated in FIG. 6, operation 566-2 may identify data transfers D1 and D2 from compute task CT1 and add edges 669-1 and 669-2 representing data transfers D1 and D2, respectively, to the workload graph 667.

At operation 566-3, the method may identify one or more compute tasks at the ends of one or more edges added in operation 566-2 and add one or more nodes corresponding to the identified compute tasks to the workload graph. For example, in the workload graph illustrated in FIG. 6, operation 566-3 may identify compute task CT2 at the end of edge 669-1 and add node 668-2 representing compute task CT2 to the workload graph 667.

At operation 566-4, the method may identify one or more IO tasks at the ends of one or more edges added in operation 566-2 and add one or more nodes corresponding to the identified IO tasks to the workload graph. For example, in the workload graph illustrated in FIG. 6, operation 566-4 may identify IO task IOT1 at the end of edge 669-2 and add node 670-1 representing IO task IOT1 to the workload graph 667.

At operation 566-5, the method may determine if there are any data transfers from any of the compute tasks and/or IO tasks added during the most recent iteration of operations 566-3 and/or 566-4, if there are any additional data transfers, the method may proceed to operation 566-6 where it may add one or more edges corresponding to the data transfers identified at operation 566-5 to the workload graph. For example, in the workload graph illustrated in FIG. 6, operation 566-5 may identify data transfer D3 from compute task CT2 and thus proceed to operation 566-6 where it may add edge 669-3 representing data transfer D3 to the workload graph 667.

The method may then proceed back to operations 566-3 and 566-4 where it may identify any additional compute tasks and/or IO tasks at the end of any edges added at operation 566-6. For example, in the workload graph illustrated in FIG. 6, operation 566-4 may identify IO task IOT2 at the end of edge 669-3 and add node 670-2 representing IO task IOT2 to the workload graph 667.

The method 566 may continue to loop through operations 566-3 through 566-6 until all of the data transfers, compute tasks, and/or IO tasks for the computational workload have been identified, and corresponding edges and/or nodes have been added to the workflow graph. The method may then end at operation 566-7. In some embodiments, the method 566 may store the workload graph 667 using a data structure such as a table, a linked list, and/or the like.

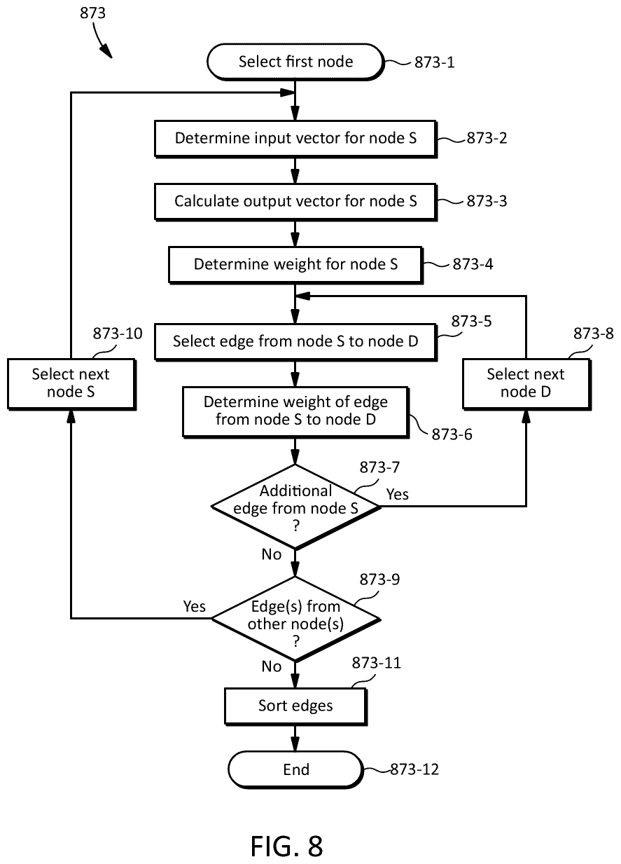

FIG. 7 illustrates an example embodiment of a workload graph having one or more nodes and/or edges in accordance with example embodiments of the disclosure. The workload graph 771 illustrated in FIG. 7 may be used to implement, and/or may be implemented with, any of the nodes and/or edges disclosed herein.

Two nodes are illustrated generically in FIG. 7 as a source node S and a destination node D which may be applied to any workload graph to determine the weight of any edge between two nodes within the graph. For example, to determine the weight D1 of the edge 669-1 between nodes 668-1 (CT1) and 668-2 (CT2) in FIG. 6, the source node S in FIG. 7 may be used to represent CT1 in FIG. 6, and the destination node) in FIG. 7 may be used to represent CT2 in FIG. 6. The mathematical structure illustrated in FIG. 7 and described below may then be used to determine the weight D1 of the edge 669-1 in FIG. 6.

Similarly, to determine the weight D2 of the edge 669-2 between nodes 668-1 (CT1) and 670-2 (IOT2) in FIG. 6, the source node S in FIG. 7 may be used to represent CT1 in FIG. 6, the destination node D in FIG. 7 may be used to represent IOT2 in FIG. 6, and the mathematical structure illustrated in FIG. 7 may then be used to determine the weight D2 of the edge 669-2 in FIG. 6.

Referring to FIG. 7, the workload graph 771 may include a first (source) node 768-S indicated as node S and/or a second (destination) node 768-D indicated as node D. Node S may include any number of inputs (e.g., M inputs) where a j-th input INj may receive a size of input data S_{INj} where j>1, 2, . . . , M. The input data to node S may form an input vector (which may also be referred to as an input set) S_{IN_VECT}={S_{IN1}, S_{IN2}, . . . , S_{INM}}, A total size of input data to node S may be given by:

$${S}_{IN \_ SIZE} = {\sum }_{j = 1}^{M} {S}_{INj} . \qquad ( Eq . 1 )$$

Node S may include any number of outputs (e.g., N outputs) where an i-th output OUTi may be associated with an output-to-input ratio (output/input ratio) kₛᵢ, One or more output/input ratios kₛᵢ may form a ratio vector (which may also be referred to as a ratio set) S_{RATIO_VECT}={ks₁, ks₂, . . . , k_{SN}}. The i-th output OUTi may transfer a size of output data S_{OUTi} where i=1, 2, . . . , N as follows:

$${S}_{OUTi} = {k}_{i} * {S}_{IN \_ SIZE} . \qquad ( Eq . 2 )$$

The output data from node S may form an output vector (which may also be referred to as an output set) S_{OUT_VECT}={S_{OUT1}, S_{OUT2}, . . . , S_{OUTN}}.

Node D may include any number of inputs (e.g., P) inputs) and/or any number of outputs (e.g., Q outputs) that may be configured and/or operate in a manner similar to the inputs and/or outputs of node S.

In some embodiments, a weight of an edge from a source node S to a destination node D may be determined as a size of data transferred from node S to node D, Thus, an edge weight EW_{SD} of an edge 769-SD from output OUT1 of node S to input IN1 of node D as illustrated in FIG. 7 may be given by:

$${EW}_{SD} = {S}_{OUT 1} . \qquad ( Eq . 3 )$$

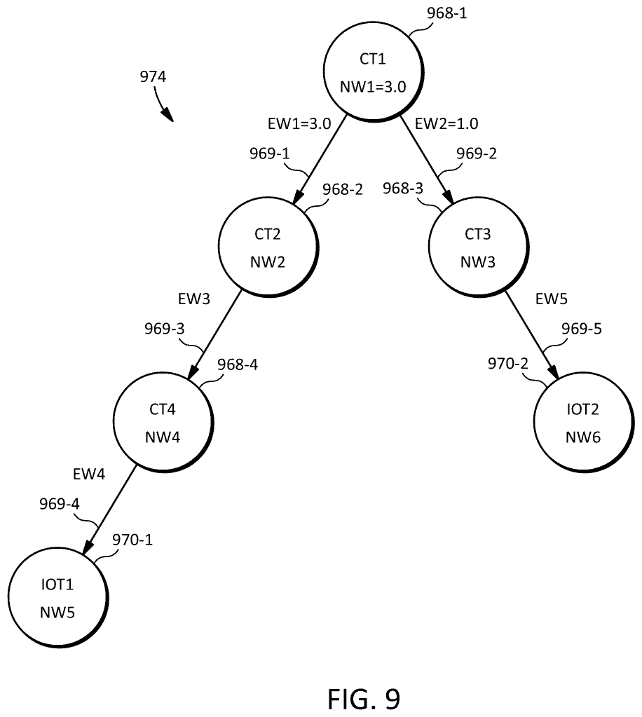

FIG. 8 illustrates an example embodiment of a method for determining one or more graph weights in accordance with example embodiments of the disclosure. The method 873 illustrated in FIG. 8 may be used, for example, to implement the graph weight estimator 252 at the system manager 239 illustrated in FIG. 2 and/or any other graph weight estimator, system manager, workflow manager, and/or the like, disclosed herein.

Weights of nodes determined using the method 873 may represent an amount of work (e.g., a computation cost in terms of units of computing power for a specific execution time, an energy consumption, and/or the like.) required to perform one or more compute tasks represented by the node. Weights of edges determined using the method 873 may represent an amount of work (e.g., a cost to transfer time in terms of units of data transferred during a specific transfer time, an energy consumption, and/or the like) required to perform a data transfer represented by an edge between two nodes.

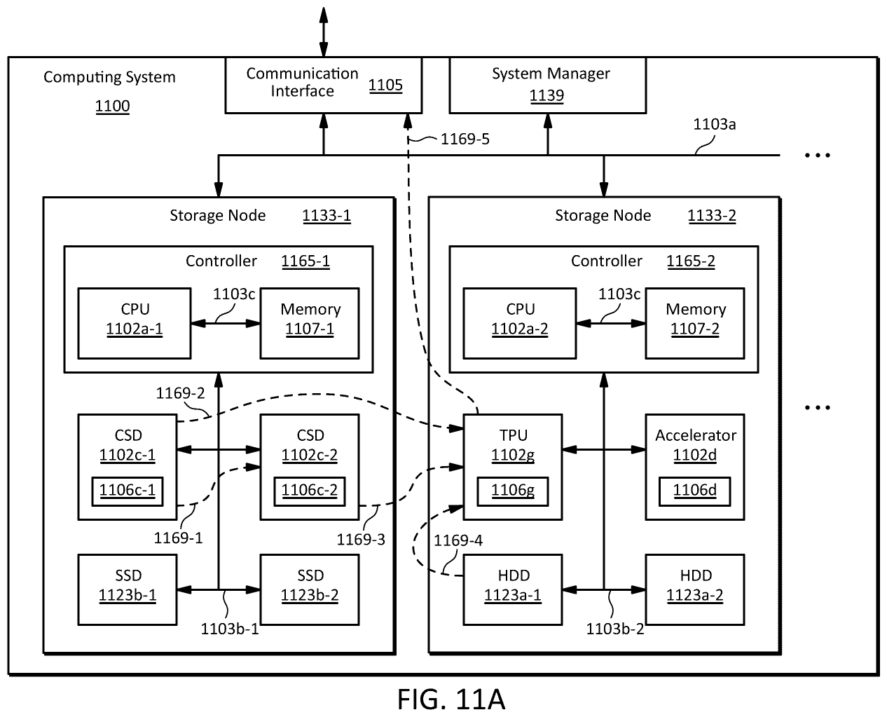

Weights determined using the method 873 illustrated in FIG. 8 may be used to estimate the performance of individual tasks on specific computational devices as well as the overall performance of a computational workload using a workload assignment in which one or more tasks of the workload are distributed to specific computational devices. For example, weights determined using the method 873 may be used by the task assignment manager 253 illustrated in FIG. 2 and/or the performance evaluation operation 1076-13 in the task assignment method 1076 illustrated in FIG. 10 to decide how to distribute different compute tasks of a computational workload.

Weights may impact decisions on how to assign compute tasks. For example, some types of compute resources may perform complex calculations (e.g., tensor calculations for AD faster and/or more efficiently than other compute resources. Therefore, a compute task having a relatively high weight may be guided toward computational devices having compute resources capable of performing complex calculations (e.g., a GPU or TPU having tensor cores).

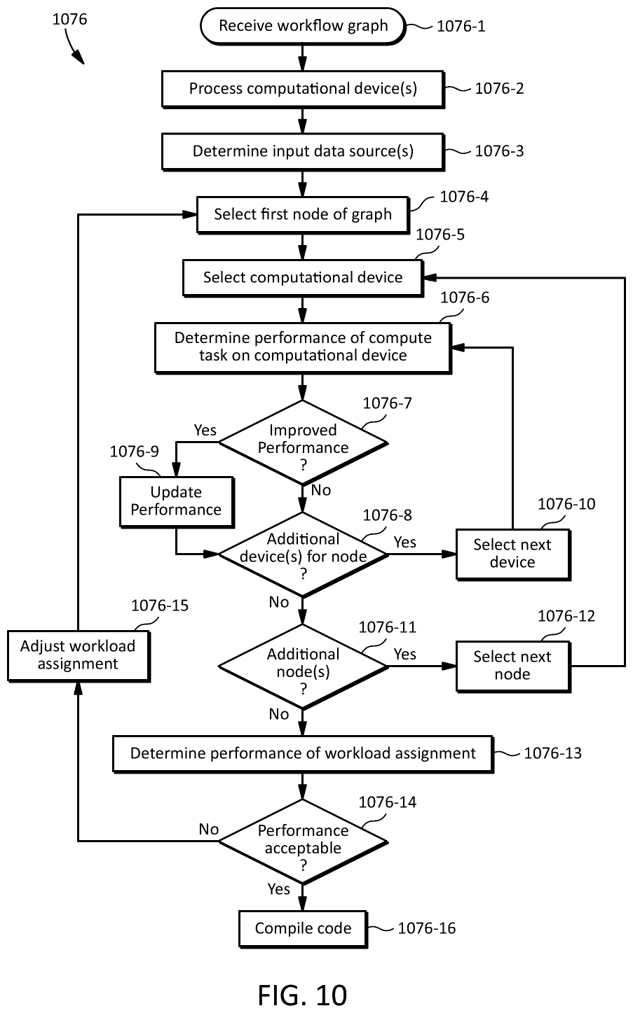

FIG. 9 illustrates an example embodiment of a workload graph having one or more weights in accordance with example embodiments of the disclosure. For purposes of illustration, the workload graph 771 illustrated in FIG. 7 and the workload graph 974 illustrated in FIG. 9 may be used to illustrate one or more operations of the method 873 illustrated in FIG. 8. However, the method 873 is not limited to any of the specific example details illustrated and/or described with respect to FIG. 7 and/or FIG. 9.

In some embodiments, the method 873 illustrated in FIG. 8 may determine (e.g., estimate) one or more data output/input ratios (e.g., output/input ratios kₛᵢ) and/or computational complexities for one or more nodes based, for example, on information such as a representation of a computational workload in one or more forms such as one or more programs, applications, data structures (e.g., tables, linked lists, and/or the like), functions, subroutines, CDFs, CSFs, measurements, user inputs (e.g., based on specifications, experience, and/or the like, that may be manually and/or programmatically enter) and/or the like. In some embodiments, one or more data output/input ratios, computational complexities and/or the like, may be used to determine one or more weights of one or more nodes and/or edges of a graph.

In some embodiments, the method 873 may be used to initialize one or more weights for a graph (e.g., determine initial weights for one or more nodes and/or edges). Additionally, or alternatively, the method 873 may be used to update (e.g., recalculate) one or more weights for one or more nodes and/or edges of a graph that has been initialized.

Referring to FIG. 7, FIG. 8, and FIG. 9, at operation 873-1, the method may select a first node of a graph (e.g., node 968-1 of graph 974) which it may designate as a source node S. At operation 873-2, the method may determine an input vector S^{IN_VECT}={S_{IN1}, S_{IN2}, . . . , S_{INM}} for node S by determining one or more data sizes S_{IN1}, S_{IN2}, . . . , S_{INM} of one or more inputs S_{IN1}, S_{IN2}, . . . , S_{INM} to node S. For example, if node S is a root node of a graph, it may have one input S_{IN1} (e.g., M=1), the input vector may have one value S_{IN_VECT} {S_{IN1}}, and the method may determine (e.g., calculate) an input data size to be S_{IN_SZE}=S_{IN1} which may be an input data size for the overall computational workload (e.g., if a graph of the workload has one root node) or a portion of the input data size for the overall computational workload (e.g., if node S is one of multiple root nodes).

In the embodiment illustrated in FIG. 9, an input data size for the computational workload may be applied to one or more inputs of node 968-1 as graph 974 may have one root node (e.g., node 968-1). In other embodiments, however, an input data size for a computational workload may be applied to (e.g., spread between) one or more inputs of one or more root nodes (e.g., as many root nodes as may be present in a graph).

At operation 873-3, the method may determine (e.g., calculate) an output vector S_{OUT_VECT}={S_{OUT1}, S_{OUT2}, . . . , S_{OUTn}} for node S, for example, using Eq. 2. In the example graph 974, node 968-1 (node S) may have two outputs (e.g., N=2), and two output/input ratios (e.g., k_{S1}=1.5, k_{S2}=0.5). Assuming an input data size of 2.0 for node S (e.g., S_{IN_SIZE}=2.0), the output vector may have two values S_{OUT_VECT}={3.0, 1.0}.

At operation 873-4, the method may determine a weight of the selected node S (e.g., node 968-1), for example, based on a complexity of a computational task CT1 implemented at node S. A complexity may be based, for example, on a complexity of one or more programs, functions, subroutines, and/or the like, implemented by computational task CT1. For example, in an embodiment in which graph node S may be implemented with a computational storage device, a weight of the selected node S may be determined based on a complexity (e.g., a relative complexity) which may be expressed, for example, as a computation cost, of a CSF performed at the computational storage device. In some embodiments, a complexity may be expressed in terms of Big O notation. For example, a compute task that may scan input data one time may be characterized as having a complexity O(n), whereas a compute task that may process an array with a double loop (and thus may input data two times) may be characterized as having a complexity O(n²).

In some embodiments, operation 873-4 may determine a weight for a node for an IO task (e.g., node 970-1 or node 970-2 in the example graph 974) based, for example, on a complexity (e.g., a relative complexity) of an IO task (e.g., IOT1 or IOT2 in the example graph 974). An IO task may involve, for example, transferring output data from a compute task to a user such as a host, application, and/or the like.

For purposes of illustration, in the example graph 974, a node weight of node 968-1 (selected node S) may be determined as NW1=3.0.

At operation 873-5, the method may select a first node, if any, having a dependency from selected node S (e.g., node 968-2 of graph 974) which it may designate as destination node D.

At operation 873-6, the method may determine a weight (e.g., an initial weight or an updated weight) for an edge between node S and node D based on an output vector for node S. In the example graph 974, an edge weight for edge 969-1 between node 968-1 and 968-2 may be determined as EW1=3.0 based on the output vector S_{OUT_VECT}={3.0, 1.0} determined at operation 873-3.

In some embodiments, an output vector may have multiple values (which may be referred to collectively as a slice of the output vector) associated with an output OUTi. Thus, an output/input ratio kₛᵢ may be applied to a su, of the values of the slice of the output vector to determine the data size S_{OUTi} of the corresponding output OUTi, and thus an edge weight of an edge corresponding to the output OUTi.

At operation 873-7, the method may determine if there are any additional destination nodes having a dependency from selected node S. If there are one or more additional destination nodes having a dependency from selected node S, the method may proceed to operation 873-8 where it may determine a next node having a dependency from selected node S. For example, in the example graph 974, an IO node 970-2 may have a dependency from selected node S. Thus, the method may proceed to operation 973-8.

At operation 873-8, the method may select node 968-3 as a next dependent node and proceed to operation 873-6 where it may determine an edge weight for edge 969-2 as EW2=1.0 based on the output vector S_{OUT_VECT}={3.0, 1.0} determined at operation 873-3.

If, however, at operation 873-7, the method determines that enough (e.g., all) nodes having a dependency from selected node S have been processed (e.g., initialized and/or updated with an edge weight), the method may proceed to operation 873-9.

At operation 873-9, the method may determine if one or more additional weights of nodes and/or edges may be initialized and/or updated (e.g., one or more nodes other than the currently selected node S and/or based on one or more dependencies from a node other than the currently selected node S).

If one or more additional nodes and/or edges may be initialized and/or updated, the method may proceed to operation 873-10 where it may select a next node to process and proceed to operation 873-2 and through one or more other operations of method 873 where it may determine (e.g., calculate) one or more weights for the next node S and/or one or more edges that may have dependencies from the next node S. For example, with the example graph 974, the method may select node 968-2 as the next node and determine a node weight NW2 for node 968-2 (e.g., based on a complexity of compute task CT2) and/or an edge weight EW3 based on an output vector S_{OUT_VECT} for node 968-2. Thus, the method 873 may traverse some or all of a graph (e.g., an entire graph) to determine one or more weights for one or more nodes and/or edges (e.g., each node and/or edge) in the graph. For example, with the graph 974 illustrated in FIG. 9, the method may continue to proceed through method 873 to traverse compute nodes 968-2, 968-3, and/or 968-4, IO nodes 970-1 and/or 970-2, and/or edges 969-3, 969-4, and/or 969-5 to determine values for CT2, CT3, CT4, IOT1, IOT2, EW3, EN4, and/or EW5.

If, at operation 873-9, the method determines that weights have been determined for enough (e.g., all) nodes and/or edges, the method may store one or more of the determined weights in a data structure and proceed to operation 873-11.

At operation 873-11, the method may process (e.g., rate, rank, sort, prioritize, and/or the like) one or more nodes and/or edges to determine one or more compute tasks that may be assigned to different computational devices. For example, with example graph 974, operation 873-1l may sort one or more (e.g., all) edges by weight to identify one or more edges that may have a significantly different weight (which may be referred to as break edges). In this example, if edge 969-2 has a relatively low weight, it may indicate that compute task CT3 may be assigned to execute on a different device than compute tasks CT1, CT2, and/or CT4 because, for example, there may be a relatively small time and/or energy associated with transferring data to a different computational device to execute compute task CT3.

FIG. 10 illustrates an example embodiment of a method for assigning one or more compute tasks to one or more computational devices in accordance with example embodiments of the disclosure. The method 1076 illustrated in FIG. 10 may be used, for example, to implement the task assignment manager 253 at the system manager 239 illustrated in FIG. 2 and/or any other graph weight estimator, system manager, workflow manager, and/or the like, disclosed herein.

In some embodiments, the method 1076 may generate a workload assignment (which may also be referred to as assignment information) that may specify one or more compute tasks and/or IO tasks assigned to one or more computational devices based on receiving a workload graph. A workload assignment may be represented, for example, using a data structure such as a table, a list, a graph (e.g., a workload graph annotated with compute task assignments), and/or the like.

At operation 1076-1, the method may receive a graph of a computational workload, for example, as part of an execution request to run on a computing system.

At operation 1076-2, the method may process (e.g., rate, rank, sort, prioritize, and/or the like) information about one or more computational devices in a computing system to enable the method to assign one or more compute tasks to the one or more computational devices. For example, the method may rank one or more computational devices based on one or more performance characteristics such as a processing performance (e.g., speed), energy efficiency, and/or the like. The method may obtain information about one or more computational devices, for example, from device profiler 250 illustrated and/or described with respect to FIG. 2.

At operation 1076-3, the method may determine one or more sources of input data for the computational workload. For example, data may be located at one or more storage computational devices 102 and/or one or more storage devices 123 such as those illustrated and/or described with respect to FIG. 2. Additionally, or alternatively, input data may be provided to the computational workload by one or more IO tasks (such as IO tasks 670 illustrated and/or described with respect to FIG. 6) that may form, or be connected to, one or more root nodes of a workload graph. The method may include one or more sources of input data (e.g., one or more devices and/or I/O tasks) in a workload assignment.

At operation 1076-4, the method may select a node of a graph (e.g., a root node) to process first. For example, the method may select a graph node representing an IO task as the first node if the input data is provided from a device that may not perform a compute task (e.g., a network device) as the first node. As another example, the method may select a node representing a compute task if the input data is present at a computational device (e.g., stored at a computational storage device).

At operation 1076-5, the method may select a first computational device on which to evaluate the first node (e.g., compute task). For example, the method may select a computational device having a relatively high performance (e.g., the most performant computational device based on processing performance and/or energy efficiency) as the first computational device. In some embodiments, a determination of a relatively high performance may be based on an available (e.g., residual) computing power of the device.

At operation 1076-6, the method may evaluate a performance of the first compute task on the first computational device, for example, by calculating an estimated completion time, energy consumption, and/or the like, for the first compute task and/or associated data transfer, which may be referred to as a current estimated performance, (For an estimate of the first compute task on the first computational device (e.g., the first time the method performs operation 1076-6), the current estimated performance may be saved as an acceptable (e.g., best) estimated performance, and the first compute task may be assigned, at least temporarily, to the first computational device.)

At operation 1076-7, the method may compare the current estimated performance to the acceptable (e.g., best) estimated performance. (The first time the method performs operation 1076-7, the current estimated performance may be the same as the acceptable (e.g., best) estimated performance.) If the current estimated performance is not an improvement over (e.g., better than) the acceptable (e.g., best) estimated performance (e.g., if the currently calculated estimated completion time, energy consumption, and/or the like is not lower than that calculated for the acceptable (e.g., best) estimated performance), the method may proceed to operation 1076-8.

If, at operation 1076-7, the current estimated performance is better than the acceptable (e.g., best) estimated performance, the method may proceed to operation 1076-9 where it may update the acceptable (e.g., best) estimated performance with the current estimated performance (e.g., the acceptable estimated performance may be replaced with the current estimated performance), and the compute task may be assigned, at least temporarily, to the computational device on which the current estimated performance was determined. The method may proceed to operation 1076-8.

At operation 1076-8, the method may determine if there are one or more computational devices on which the first compute task may be evaluated. If there are one or more computational devices on which the first compute task may be evaluated, the method may proceed to operation 1076-10 at which the method may select another (e.g., a next most performant) computational device and proceed to operation 1076-6.

If, at operation 1076-8, the method determines that the first compute task has been evaluated on enough (e.g., all) computational devices in the system, the first compute task may remain assigned to the computational device on which it has an acceptable (e.g., the best) estimated performance, and the method may proceed to operation 1076-11.

Thus, operations 1076-5, 1076-6, 1076-7, 1076-8, 1076-9, and/or 1706-10 may form an inner loop in which the method may evaluate the performance of the first compute task on one or more (e.g., all) available computational devices to determine which computational device may provide an acceptable (e.g., the best) estimated performance and assign the first compute task, at least temporarily, to the computational device that may provide an acceptable (e.g., best) estimated performance.

At operation 1076-11, the method may determine if enough (e.g., all) nodes of the graph (corresponding to compute tasks) have been assigned to one or more computational devices. If one or more nodes remain to be assigned, the method may proceed to operation 1076-12 where the task may select a next compute task (e.g., node of the graph) and proceed to operation 1076-5.

Beginning at operation 1076-5, the method may proceed one or more times through the inner loop that may include operations 1076-5, 1076-6, 1076-7, 1076-8, 1076-9, and/or 1076-10 in a manner similar to that described above for the first compute task to determine a computational device to which to assign the next compute task. Depending on the implementation details and/or one or more characteristics of one or more compute tasks, computational devices, results of one or more computed estimated performances, and/or the like, the inner loop may assign the next compute task to the same computational device as the first compute task or to a different computational device.

At operation 1076-11, if the method determines that enough (e.g., all) compute tasks (corresponding to nodes of the graph) have been assigned to one or more computational devices, the method may proceed to operation 1076-13. Additionally, or alternatively, at operation 1076-11, the method may determine that a number of assigned devices may equal a number of compute tasks in the computational workload (e.g., nodes in the graph), and thus, the method may proceed to operation 1076-13.

Thus, operations 1076-11, 1076-12, and/or the inner loop may form a middle loop that may repeat the inner loop for one or more (e.g., all) compute tasks in the computational workload (e.g., nodes in the graph) to determine one or more computational devices to which to assign the one or more (e.g., all) compute tasks to determine a workload assignment. In some embodiments, the middle loop may progress through one or more nodes of the graph (e.g., may traverse the graph) to ensure that one or more (e.g., all) compute tasks are assigned to one or more computational devices to create a workload assignment.

At operation 1076-13, the method may determine a first estimated performance (e.g., an estimated overall performance) for the workload assignment.

For example, a performance P (e.g., an overall performance) of a workload assignment may be determined by:

$$P = {\sum }_{x = 1}^{X} {ExecuteTime}_{x} + {\sum }_{x = 1 , y = 1}^{X , Y} {TransferTime}_{xy} \qquad ( Eq . 4 )$$

where ExecutTimeₓ indicates an execution time of a compute task CTx (or IO time for an IO task) on an assigned computational device, and TransferTime_{xy} indicates a transfer time to transfer data from a node x (e.g., a computational device to which CTx may be assigned) to a node y (e.g., a device to which a compute task or IO task having a data dependency on node x may be assigned), X may be a number of compute tasks (and/or IO tasks), and Y may be a number of nodes having a data dependency on one or more (e.g., each) corresponding node x. Based on determining a first performance P for a workload assignment, the method may proceed to operation 1076-14.

In some embodiments, some or all of a determination of an estimated overall workload performance (e.g., as may be implemented with Eq. 4) may be implemented, at least partially, in an inner loop and/or a middle loop. For example, at operation 1076-6, in addition to determining a performance of a specific compute task on a specific computational device, operation 1076-6 may also determine and/or consider one or more effects an assignment of the specific compute task the specific computational device may have on an overall performance of the computational workload on the computing system.

At operation 1076-14, the method may determine whether a workload assignment created by the inner and/or middle loops is acceptable. For example, operation 1076-14 may determine that an energy consumption of a first performance P of a workload assignment may exceed one or more energy consumption caps. An energy consumption cap may be implemented on a per compute task basis, a per computational device basis, a workload basis, a computing system basis, and/or the like.

If, at operation 1076-14, the method determines that of a first performance P of a workload assignment exceeds an energy consumption cap, the method may proceed to operation 1076-15 where the method may adjust one or more aspects of the workload assignment. For example, at operation 1076-14, the method may determine that one or more specific compute tasks that have been assigned to one or more specific CPUs may consume a relatively large amount of energy that may cause the workload assignment to exceed an overall system energy consumption cap. Thus, at operation 1076-15, the method may impose a constraint that may cause (e.g., require) the one or more specific compute tasks to be assigned to one or more GlPis which, depending on the implementation details, may execute the one or more specific compute tasks using less energy. The method may proceed to operation 1076-4 and proceed one or more times through the inner loop and/or middle loop to determine, using the constraint, a new workload assignment.

At operation 1076-13, the method may determine a second performance P (e.g., a second overall performance) of the new workload assignment. At operation 1076-14, the method may determine whether the second performance P of the new workload assignment is acceptable. If the second performance P of the new workload assignment is not acceptable, the method may proceed to operation 1076-15 and adjust one or more aspects of the new workload assignment (e.g., impose one or more additional constraints) and proceed one or more times through the inner loop and/or middle loop to determine, using the one or more additional constraints, another new workload assignment.

Thus, the operations 1076-14, 1076-15, 1076-4, the inner loop, and/or middle loop may form an outer loop that may, depending on the implementation details, determine one or more workload assignments, for example, until an acceptable workload assignment is determined for the computational workload.

As another example of adjusting a workload assignment, at operation 1076-14, the method may determine that a performance of a workload assignment may be improved by adjusting one or more aspects of the workload assignment. For example, in one implementation, the inner loop and/or middle loop may create a first workload assignment for the example workload graph illustrated in FIG. 9 in which compute tasks CT1, CT2, CT3, and CT4 may be assigned to one computational device because. The four compute tasks may take a relatively long time to execute on the one computational device, but, depending on the implementation details, the overall data transfer time may be relatively low, and thus, the method may determine a first performance of the first workload assignment.

However, at operation 1076-14, the method may determine that executing compute task CT3 at a different computational device than CT1. CT2, and/or CT3 may improve the overall performance of the computational workload. Thus, the method may proceed to operation 1076-15 where it may impose a constraint on the inner loop and/or middle loop to assign CT3 to a different computational device than CT1, CT2, and/or CT3. Using this constraint, the inner loop and/or middle loop may create a second workload assignment, and at operation 1076-13, the method may determine a second performance of the second workload assignment. At operation 1076-14, the method may compare the first performance with the second performance and adopt the workload assignment that may provide better overall performance based, for example, on execution time, energy efficiency, and/or the like.

In some embodiments, the method 1076 may create multiple workload assignments for a computational workload, determine an estimated performance for one or more (e.g., each) of the workload assignments, and select one of the workload assignments based on the one or more estimated performances. Some may select a workload assignment that may reduce (e.g., minimize) execution time and/or data transfer time. For example, in some embodiments, the method 1076 may select a workload assignment having a performance P based on the following equation:

$$P = min \{ {\sum }_{x = 1}^{X} {ExecuteTime}_{x} + {\sum }_{x = 1 , y = 1}^{X , Y} {TransferTime}_{xy} \} . \qquad ( Eq . 5 )$$

If, at operation 1076-14, the method determines that an acceptable workload assignment has been created, it may proceed to operation 1076-16 where it may compile code to perform the one or more compute tasks (and/or IO tasks) on one or more computational devices to which the one or more tasks have been assigned.

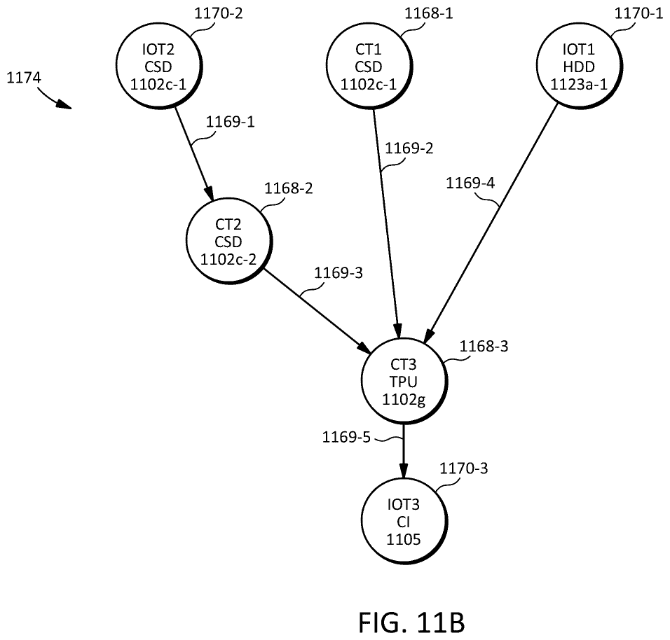

FIG. 11A illustrates an embodiment of a computing system with a task assignment manager in accordance with example embodiments of the disclosure. The computing system 1100 illustrated in FIG. 11A may be used, for example, to implement any of the compute task assignment schemes disclosed herein, including those illustrated and/or described with respect to other drawings in which similar elements may be indicated by reference numbers ending in, and/or containing, the same digits, letters, and/or the like. The computing system 1100 may include components similar to those in the embodiment illustrated in FIG. 1A. However, in the computing system 1100 illustrated in FIG. 11A, the system manager 1139 may implement a compute task assignment scheme in accordance with example embodiments of the disclosure.

Although the computing system 1100 illustrated in FIG. 11A is not limited to any specific operations, for one example computational workload that may be performed using the system 1100, the system manager 1139 may generate a workload graph (e.g., using a workload graph builder similar to that illustrated and/or described with respect to FIG. 2 and/or FIG. 6) as illustrated in FIG. 11B.

FIG. 11 illustrates an example embodiment of a graph for a computational workload in accordance with example embodiments of the disclosure. The graph 1174 may be used, for example, to illustrate a workload assignment that may be performed using the computing system 1100 illustrated in FIG. 11A. In some embodiments, the system manager 1139 may assign one or more weights to one or more nodes and/or edges of the graph (e.g., using a graph weight estimator similar to that illustrated and/or described with respect to FIG. 2 and/or FIG. 8).

In the computing system 1100 illustrated in FIG. 11A, data transfers between one or more components (e.g., to implement one or more edges of the graph 1174 illustrated in FIG. 11B) may flow through the system 1100 as shown by dashed lines.

Referring to FIG. 11A and FIG. 11B, a first portion of input data (e.g., one or more operands) for a computational workload may initially be stored at a computational storage device 1102c-1 at storage node 1133-1, and a second portion of input data for the computational workload may initially be stored at storage device 1123a-1 at storage node 1133-2, Thus, the graph 1174 may have at least two root storage nodes because input data may be provided from two locations. A first root node 1168-1 may represent a first compute task CT1, and a second root node 1170-1 may represent an IO task IOT1. The system manager 1139 may assign the compute task CT1 to the computational storage device 1102c-1 (e.g., using task assignment manager similar to that illustrated and/or described with respect to FIG. 2 and/or FIG. 10). Compute task CT1 may use at least a portion of the input data located at the computational storage device 1102c-1, The system manager 1139 may assign the IO task IOT1 (e.g., reading data from the storage device 1123a-1) to the storage device 1123a-1.

However, the system manager 1139 may implement a workload assignment that may transfer some of the input data from the computational storage device 1102c-1 to a second computational storage device 1102c-2 at storage node 1133-1. Thus, the graph 1174 may have a third root node 1170-2 associated with this data transfer. The system manager 1139 may assign an IO task IOT2 (e.g reading data from the computational storage device 1102c-1) to the storage device 1102c-1.

The graph 1174 may include a second compute task CT2 which the system manager 1139 may assign to the second computational storage device 1102c-2, and a third compute task CT3 which the system manager 1139 may assign to a TPU 1102g at the storage node 1133-2. The graph 1174 may also include a third IO task IOT3 which the system manager 1139 may assign to a communication interface (CI) 1105.

The graph 1174 may include a first edge 1169-1 representing a data transfer from the first computational storage device 1102c-1 to the second computational storage device 1102c-2.

The graph 1174 may include a second edge 1169-2 representing a data transfer (e.g., output data from CT1) from the first computational storage device 1102c-1 to the TPU 1102g.

The graph 1174 may include a third edge 1169-3 representing a data transfer (e.g., output data from CT2) from the second computational storage device 1102c-2 to the TPU 1102g.

The graph 1174 may include a fourth edge 1169-4 representing a data transfer (e.g., input data stored at storage device 1123a-1) from the storage device 1123a-1 to the TPU 1102g.

The graph 1174 may include a fifth edge 1169-5 representing a data transfer (e.g., output data from CT3) from the TPU 1102g to the communication interface 1105.

Referring to FIG. 11A, the system 1100 may perform the computational workload represented by the graph 1174 as follows. The first computational storage device 1102c-1 may execute a first compute task CT1 using a portion of the input data stored at the first computational storage device 1102c-1. The first computational storage device 1102c-1 may transfer output data from compute task CT1 to the TPU 1102g (indicated by edge 1169-2 representing a data dependency of compute task CT3 on compute task CT2), The first computational storage device 1102c-1 may also transfer output data from compute task CT1 to the second computational storage device 1102c-2 as illustrated by edge 1169-1.

The second computational storage device 1102c-2 may execute a second compute task CT2 using a portion of the input data stored at and/or output from the first computational storage device 1102c-1 as input. The second computational storage device 1102c-2 may transfer output data from compute task CT2 to the TPU 1102g (indicated by edge 1169-3 representing a data dependency of compute task CT3 on compute task CT2).

Storage device 1123a-1 may transfer output information to TPU 1102g as indicated in node 1170-1 and edge 1169-4.

The TPU 1102g may execute a third compute task CT3 using data transferred from compute task CT1 and compute task CT2 as well as IO task IOT1 as input data. For example, the TPU 1102g may perform further processing on the output data transferred from CT1 and/or CT2. The TPU 1102g may transfer output data from CT3 to the communication interface 1105 (indicated by edge 1169-5 representing a data dependency of IO task 1013 on compute task CT3).

The communication interface 1105 may execute IO task IOT3, for example, transferring result data from compute task CT3 to a host or other user of the computing system 1100.

In some embodiments, the system manager 1139 may adjust one or more aspects of the graph 1174 and/or assignments based, for example, on one or more factors such as data volume, computation complexity, data dependencies, energy efficiency, and/or the like (for example, as such factors may have influenced the node and edge weights for relevant tasks). For example, compute task CT1 (which is assigned to first computational storage device 1102c-1) may have a dependency on input data stored at two locations: (1) the remote storage device 1123a-1, and (2) the first computational storage device 1102c-1 at which CT1 will be executed. In such a situation, an acceptable (e.g., optimized) workload assignment may depend on how much of the total data is stored in each location, as well as the bandwidth and/or the latency for data transfers between the two locations.

If the amount of data stored at the remote storage device 1123a-1 is larger than the amount of data stored at the first computational storage device 1102c-1, the system manager 1139 may modify the workload assignment (and graph 1174) to transfer the data from the remote storage device 1123a-1 to the first computational storage device 1102c-1 and execute CT1 at the first computational storage device 1102c-1.

If, however, the amount of data stored at the remote storage device 1123a-1 is smaller (e.g., much smaller) than the amount of data stored at the first computational storage device 1102c-1, the system manager 1139 may modify the workload assignment (and graph 1174) to transfer the input data stored at both locations (the first computational storage device 1102c-1 and the remote storage device 1123a-1) to the TPU 1102g and/or the accelerator 1102d, and execute the compute task CT1 on the TPU 1102g and/or the accelerator 1102d. This modified workload assignment may perform better, for example, because the greater processing power and/or efficiency of the TPU 1102g and/or the accelerator 1102d may outweigh the time and/or energy consumption associated with transferring the input data from both storage locations to the TPU 1102g and/or the accelerator 1102d.

In some embodiments, and depending on the implementation details, a compute task assignment scheme in accordance with example embodiments of the disclosure may improve a total cost of ownership (TCO) of one or more computational devices, may enable one or more existing and/or retiring computational devices to be used (e.g., repurposed) for compute tasks, may enable a storage server, storage cluster, and/or the like, to be adapted for computational storage, may enable improved (e.g., optimized) distribution of compute tasks to one or more computational devices, and/or the like.

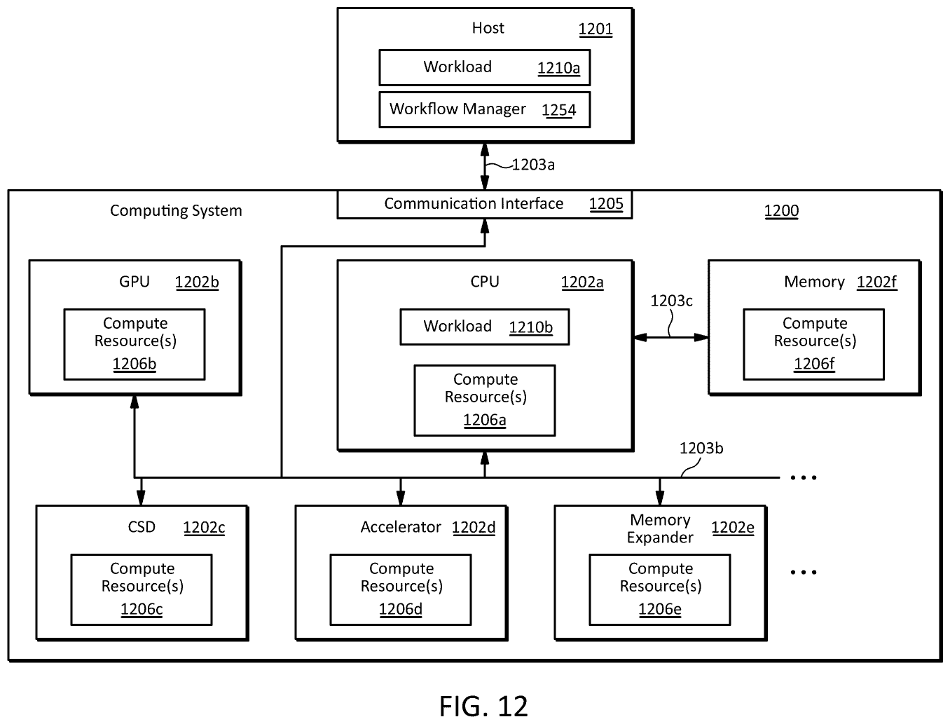

FIG. 12 illustrates an example embodiment of a computing system in accordance with example embodiments of the disclosure. The computing system 1200 illustrated in FIG. 12 may be used to implement any of the assignment schemes disclosed herein, including those described with respect to other drawings in which similar elements may be indicated by reference numbers ending in, and/or containing, the same digits, letters, and/or the like.

For purposes of illustration, the computing system 1200 illustrated in FIG. 12 may be described in the context of a system in which computational devices may communicate using an interconnect physical (PHY) layer such as a PCIe physical layer with one or more protocols such as a PCIe protocol, CXL.cache, CXL.mem, CXL.io, and/or the like. However, aspects of the disclosure may be implemented with computational devices using any other communication scheme such as computational devices that may communicate using network infrastructure (e.g., a network fabric) based, for example, on an Ethernet protocol.

The computing system 1200 may include one or more CPUs 1202a, one or more GPUs 1202b, one or more computational storage devices 1202c, one or more accelerators 1202d, one or more memory expanders 1202e, one or more memory devices 1202f, and/or the like, which may be referred to individually and/or collectively as 1202. The one or more CPUs 1202a, GPUs 1202b, computational storage devices 1202c, accelerators 1202d, memory expanders 1202c, and/or memory devices 1202f may include compute resources 1206a, 1206b, 1206c, 1206d, 1206e, and/or 1206f, respectively, which may be referred to individually and/or collectively as 1206.

FIG. 12 also illustrates a host 1201 which may be separate from and/or integrated with, the computing system 1200. For example, in some embodiments, a host 1201 may be implemented as a separate component that may run a workload 1210a that may offload one or more compute tasks to one or more computational devices 1202 in the computing system 1200. In some other embodiments, a CPU 1202a may function as a host that may run a workload 1210b that may offload one or more compute tasks to one or more other computational devices 1202. In such an embodiment, a CPU 1202a (either the CPU that runs the workload 1210b or a different CPU) may also function as a computational device. In yet other embodiments, a workload 1210 may run partially on a separate host 1201 and partially on one or more CPUs 1202a and offload one or more compute tasks to one or more other computational devices 1202.

In some embodiments, the computing system 1200 may include a workflow manager 1254 that may implement any or all of the compute task assignment schemes disclosed herein, or one or more portions thereof. For example, the workflow manager 1254 may include one or more system managers, device profiler, workload graph builders, graph weight estimators, task assignment manager, and/or the like. In some embodiments, the workflow manager 1254 may be located at least partially at host 1201 as illustrated in FIG. 12, In some embodiments, some or all of the workflow manager 1254 may be located at multiple hosts, at one or more computational devices 1202, at a user of the computing system 1200, and/or at any other location.

The computational devices 1202 may communicate using one or more communication connections 1203a which, as mentioned above, in some embodiments, may be implemented using a PCIe physical layer with one or more protocols such as a PCIe protocol, CXL.cache, CXL.mem, CXL.io, and/or the like. In such an embodiment, any of the computational devices 1202 may be implemented with one or more mechanical configurations compatible with a PCIe physical layer including form factors such as adapter card form factors (e.g., PCIe adapter cards), storage device form factors (e.g., 3.5 inch, 2.5 inch, M.2, and/or EBDSFF form factors such as E1.S, E1.L, E3.S, and/or E3.L), and/or the like. Also in such an embodiment, any of the computational devices 1202 may be implemented with one or more connectors configurations compatible with a PCIe physical layer such as card edge connectors (e.g., PCIe card edge connectors), U.2 connectors, U.3 connectors, EDSFF connectors (e.g., connectors Compatible with SFF-TA-1002 and/or SFF-TA-1009), M.2 connectors, and/or the like.

In embodiments that use an interconnect physical layer such as a PCIe PHY layer, one or more of the communication connections 1203 may be implemented with one or more PCIe fabrics that may include one or more root complexes, switches, retimers, and/or the like. For example, one or more communication connections 1203b may be implemented with one or more root complexes at a CPU 1202a and/or one or more switches that may enable a CPU 1202a to communicate with any of the other computational devices 1202, as well as a communication interface 1205 (e.g., a network interface card or controller, an interconnect card or controller, and/or the like) that may enable the computational system 1200 to communicate with a host 1201. In embodiments in which a host 1201 may be at least partially separate from the computational system 1200, one or more communication connections 1203a may be implemented with an interconnect such as PCIe, a network such as Ethernet, and/or the like.

In some embodiments, a computational device 1202f may be implemented with a memory module form factor such as a dual inline memory module (DIMM) that may implement one or more communication connections 1203c with a memory interface such as a double data rate (DDR) memory interface. In such an embodiment, one or more compute resources 1206f at a computational device 1202f may be implemented, for example, with processing-in-memory (PIM) functionality that may include computing resources on one or more memory dies, on one or more logic dies connected to (e.g., stacked with) one or more memory dies, and/or the like.

Although the computational system 1200 is not limited to any specific physical configuration, in some embodiments, the computational system 1200 may be implemented with a server such as a compute server, a storage server, and/or the like, configured as one or more chassis, blades, racks, clusters, datacenters, edge datacenters, and/or the like.

The embodiments illustrated herein are example operations and/or components. In some embodiments, some operations and/or components may be omitted and/or other operations and/or components may be included. Moreover, in some embodiments, the temporal and/or spatial order of the operations and/or components may be varied, Although some components and/or operations may be illustrated as individual components, in some embodiments, some components and/or operations shown separately may be integrated into single components and/or operations, and/or some components and/or operations shown as single components and/or operations may be implemented with multiple components and/or operations.

Any of the functionality described herein, including any of the system managers, device profilers, workload graph builder, graph weight estimator, task assignment manager, device controllers, and/or the like, may be implemented with one or more control circuits that may include hardware, software, firmware, or any combination thereof including, for example, hardware and/or software combinational logic, sequential logic, timers, counters, registers, state machines, volatile memories such DRAM and/or SRAM, nonvolatile memory including flash memory, persistent memory such as cross-gridded nonvolatile memory, memory with bulk resistance change, PCM, and/or the like and/or any combination thereof, CPLDs, FPGAs, ASICs, CPUs including CISC processors such as x86 processors and/or RISC processors such as ARM processors, GPLs, NPUs, TPUs, and/or the like, executing instructions stored in any type of memory. In some embodiments, one or more components may be implemented as a system-on-chip (SOC), system in package (SIP), multi-chip module, one or more chiplets (e.g., integrated circuit (IC) dies) in a package, and/or the like.

Some embodiments disclosed above may be described in the context of various implementation details, but the principles of this disclosure are not limited to these or any other specific details. For example, some functionality has been described as being implemented by certain components, but in other embodiments, the functionality may be distributed between different systems and components in different locations and having various user interfaces. Certain embodiments have been described as having specific processes, operations, etc., but these terms also encompass embodiments in which a specific process, operation, etc. may be implemented with multiple processes, operations, etc., or in which multiple processes, operations, etc. may be integrated into a single process, step, etc. A reference to a component or element may refer to only a portion of the component or element. For example, a reference to a block may refer to the entire block or one or more subblocks. The use of terms such as “first” and “second” in this disclosure and the claims may only be for purposes of distinguishing the elements they modify and may not indicate any spatial or temporal order unless apparent otherwise from context. In some embodiments, a reference to an element may refer to at least a portion of the element, for example, “based on” may refer to “based at least in part on,” and/or the like. A reference to a first element may not imply the existence of a second element. The principles disclosed herein have independent utility and may be embodied individually, and not every embodiment may utilize every principle. However, the principles may also be embodied in various combinations, some of which may amplify the benefits of the individual principles in a synergistic manner. The various details and embodiments described above may be combined to produce additional embodiments according to the inventive principles of this patent disclosure.

Since the inventive principles of this patent disclosure may be modified in arrangement and detail without departing from the inventive concepts, such changes and modifications are considered to fall within the scope of the following claims.

1. A method comprising:
determining, by at least one control circuit, a first performance of a first compute task on one or more computational devices, wherein the first performance is determined based on a first weight of the first compute task;
determining, by the at least one control circuit, a second performance of a second compute task on the one or more computational devices; and
assigning, by the at least one control circuit, based on the first performance and the second performance, the first compute task to at least one of the one or more computational devices.

2. The method of claim 1, wherein the second performance is determined based on a second weight of the second compute task.

3. The method of claim 1, further comprising determining, based on a characteristic of the first compute task, the first weight.

4. The method of claim 3, wherein the characteristic of the first compute task comprises at least one of a type of the first compute task, computational complexity of the first compute task, priority of the first compute task, latency of the first compute task, or amount of data used by the first compute task.

5. The method of claim 1, further comprising assigning, by the at least one control circuit, based on the first performance and the second performance, the second compute task to the at least one of the one or more computational devices.

6. The method of claim 1, wherein the at least one of the one or more computational devices comprises a first one of the one or more computational devices, the method further comprising assigning, by the at least one control circuit, based on the first performance and the second performance, the second compute task to a second one of the one or more computational devices.

7. The method of claim 1, further comprising:
determining a weight of a data transfer associated with the first compute task;
wherein the determining the first performance is based on the weight of the data transfer associated with the first compute task.

8. The method of claim 7, wherein the weight of a data transfer associated with the first compute task is based on at least one of an amount of data transferred by the data transfer, a latency of the data transfer, a type of data access operation associated with the data transfer, or a location of data transferred by the data transfer.

9. The method of claim 1, wherein the first performance comprises an execution speed.

10. The method of claim 1, wherein the first performance comprises an energy consumption.

11. The method of claim 1, wherein:
the at least one of the one or more computational devices comprises a first one of the one or more computational devices;
the method further comprises determining a characteristic of the first one of the one or more computational devices; and
the determining the first performance is based on the characteristic of the first one of the one or more computational devices.

12. The method of claim 11, wherein the characteristic of the first one of the one or more computational devices comprises at least one of a processing power, energy consumption, or data transfer rate.

13. The method of claim 11, wherein:
the method further comprises determining a characteristic of a second one of the one or more computational devices; and
the determining the second performance is based on the characteristic of the second one of the one or more computational devices.

14. The method of claim 1, wherein the first compute task comprises at least one instruction, the method further comprising compiling, based on the assigning, the at least one instruction for the at least one of the one or more computational devices.

15. A method comprising:
determining, by at least one control circuit, a first performance of a computational workload comprising a compute task and a data transfer associated with the compute task, wherein the first performance is determined based on:
a weight of the data transfer; and
a second performance of the compute task on at least one of one or more computational devices; and
assigning, by the at least one control circuit, based on the first performance, the compute task to the at least one of the one or more computational devices.

16. The method of claim 15, further comprising determining, based on a characteristic of the data transfer, the weight of the data transfer.

17. The method of claim 16, wherein the weight of the data transfer is based on at least one of an amount of data transferred by the data transfer, a latency of the data transfer, a type of data access operation associated with the data transfer, or a location of data transferred by the data transfer.

18. A system comprising:
one or more computational devices; and
at least one control circuit configured to:
determine a first performance of a compute task on at least a first one of the one or more the computational devices, wherein the first performance of the compute task is based on a weight of the compute task;
determine a second performance of the compute task on at least a second one of the one or more the computational devices; and
assign, based on the first performance and the second performance, the compute task to the first one of the one or more computational devices.

19. The system of claim 18, wherein the weight of the compute task is based on a characteristic of the compute task.

20. The system of claim 19, wherein the characteristic of the compute task comprises at least one of a type of the compute task, computational complexity of the compute task, priority of the compute task, latency of the compute task, or amount of data used by the compute task.
